(19) United States
(12) Patent Application Publication
(10) Pub. No.: US 2024/0334530 A1
(43) Pub. Date: Oct. 3, 2024

(54) FIRST RADIO COMMUNICATION DEVICE, SECOND RADIO COMMUNICATION DEVICE, COMMUNICATION METHOD, AND COMMUNICATION PROGRAM

(71) Applicant: FUJITSU LIMITED, Kawasaki-shi (JP)

(72) Inventors: Takako HORI, Sagamihara (JP); Yoshiaki OHTA, Yokohama (JP)

(73) Assignee: FUJITSU LIMITED, Kawasaki-shi (JP)

(21) Appl. No.: 18/733,362

(22) Filed: Jun. 4, 2024

Related U.S. Application Data
(63) Continuation of application No. PCT/JP2021/046147, filed on Dec. 14, 2021.

(51) Int. Cl. H04W 76/20; H04W 12/041; H04W 12/043; H04W 76/19

(52) U.S. Cl. CPC H04W 76/20; H04W 12/041; H04W 12/043; H04W 76/19

(57) ABSTRACT

A second radio communication device includes, a receiver configured to receive a Radio Resource Control (RRC) message from a first radio communication device, and a controller configured to, when the RRC message includes a first parameter and a second parameter, control to perform processing according to the second parameter after performing processing of resuming a radio bearer in a suspended state.

### CROSS-REFERENCE TO RELATED APPLICATION

This application is a continuation application of International Application PCT/JP2021/046147 filed on Dec. 14, 2021 and designated the U.S., the entire contents of which are incorporated herein by reference.

### FIELD

The present disclosure relates to a radio communication device.

### BACKGROUND

Currently, radio communication networks using mobile terminals (smartphones and feature phones) are expanding. With the expansion of radio communications, higher speeds and larger capacities are sought.

Technologies that achieve higher speed and larger capacity include Dual Connectivity (DC). DC is a technology in which a terminal device wirelessly connects to a master base station device and a secondary base station device, and performs radio communication using the carriers of the base station devices (hereinafter may be referred to as cell groups).

Furthermore, as the generations of radio communication standard progress, attention has been directed toward Multi Radio Dual Connectivity (MR-DC), which is a DC technology that uses eNodeB (hereinafter may be referred to as eNB), which is a base station device associated with Evolved Terrestrial Radio Access (E-UTRA), which is a Radio Access Technology (RAT) for 3.9G, Four-Generation (4G), and 4G-advanced, and gNodeB (hereinafter may be referred to as gNB), which is a base station device associated with New Radio (NR), which is a radio access technology for Five-Generation (5G) and 5G-Advanced. MR-DC also includes DC in which both the master base station device and the secondary base station device are gNBs.

When the amount of data to be transmitted and received in MR-DC is large, the terminal device transmits and receives data to and from both the master base station device and the secondary base station device, for example. On the other hand, when the amount of data to be transmitted and received in MR-DC is small, measures have been contemplated to save power by suspending data communication between the terminal device and the secondary base station device by deactivating the cell group (secondary cell group) belonging to the secondary base station device.

Technologies relating to MR-DC are described in the following related art literature.

### CITATION LIST

### Non-Patent Literature

Non-Patent Literature 1: 3GPP TS36.133 LTE-A Radio Measurement Specification Version 16.0.0
Non-Patent Literature 2: 3GPP TS36.300 LTE-A Overview Specification Version 16.0.0 Non-Patent Literature 3: 3GPP TS36.211 LTE-A PHY Channel Specification Version 16.0.0
Non-Patent Literature 4: 3GPP TS36.212 LTE-A PHY Encoding Specification Version 16.0.0
Non-Patent Literature 5: 3GPP TS36.213 LTE-A PHY Procedure Specification Version 16.0.0
Non-Patent Literature 6: 3GPP TS36.214 LTE-A PHY Measurement Specification Version 16.0.0
Non-Patent Literature 7: 3GPP TS36.321 LTE-A MAC Specification Version 16.0.0
Non-Patent Literature 8: 3GPP TS36.322 LTE-A RLC Specification Version 16.0.0
Non-Patent Literature 9: 3GPP TS36.323 LTE-A PDCP Specification Version 16.0.0
Non-Patent Literature 10: 3GPP TS36.331 LTE-A RRC Specification Version 16.0.0
Non-Patent Literature 11: 3GPP TS36.413 LTE-A S1 Specification Version 16.0.0
Non-Patent Literature 12: 3GPP TS36.423 LTE-A X2 Specification Version 16.0.0
Non-Patent Literature 13: 3GPP TS36.425 LTE-A Xn Specification Version 16.0.0
Non-Patent Literature 14: 3GPP TR36.912 NR Radio Access Overview Version 16.0.0
Non-Patent Literature 15: 3GPP TR38.913 NR Requirements Version 16.0.0
Non-Patent Literature 16: 3GPP TR38.913 NR Requirements Version 16.0.0
Non-Patent Literature 17: 3GPP TR38.801 NR Network Architecture Overview Version 14.0.0
Non-Patent Literature 18: 3GPP TR38.802 NR PHY Overview Version 14.2.0
Non-Patent Literature 19: 3GPP TR38.803 NR RF Overview Version 14.2.0
Non-Patent Literature 20: 3GPP TR38.804 NR L2 Overview Version 14.0.0
Non-Patent Literature 21: 3GPP TR38.900 NR High Frequency Overview Version 14.0.0
Non-Patent Literature 22: 3GPP TS38.300 NR Overview Specification Version 16.0.0 Non-Patent Literature 23: 3GPP TS37.340 NR Multiple Access Overview Specification Version 16.0.0
Non-Patent Literature 24: 3GPP TS38.201 NR PHY Specification Overview Specification Version 16.0.0
Non-Patent Literature 25: 3GPP TS38.202 NR PHY Service Overview Specification Version 16.0.0
Non-Patent Literature 26: 3GPP TS38.211 NR PHY Channel Specification Version 16.0.0
Non-Patent Literature 27: 3GPP TS38.212 NR PHY Encoding Specification Version 16.0.0
Non-Patent Literature 28: 3GPP TS38.213 NR PHY Data Channel Procedure Specification Version 16.0.0
Non-Patent Literature 29: 3GPP TS38.214 NR PHY Control Channel Procedure Specification Version 16.0.0
Non-Patent Literature 30: 3GPP TS38.215 NR PHY Measurement Specification Version 16.0.0
Non-Patent Literature 31: 3GPP TS38.321 NR MAC Specification Version 16.0.0
Non-Patent Literature 32: 3GPP TS38.322 NR RLC Specification Version 16.0.0
Non-Patent Literature 33: 3GPP TS38.323 NR PDCP Specification Version 16.0.0
Non-Patent Literature 34: 3GPP TS37.324 NR SDAP Specification Version 16.0.0
Non-Patent Literature 35: 3GPP TS38.331 NR RRC Specification Version 16.0.0
Non-Patent Literature 36: 3GPP TS38.401 NR Architecture Overview Specification Version 16.0.0
Non-Patent Literature 37: 3GPP TS38.410 NR Core Network Overview Specification Version 16.0.0
Non-Patent Literature 38: 3GPP TS38.413 NR Core Network AP Specification Version 16.0.0
Non-Patent Literature 39: 3GPP TS38.420 NR Xn Interface Overview Specification Version 16.0.0
Non-Patent Literature 40: 3GPP TS38.423 NR XnAP specification Version 16.0.0
Non-Patent Literature 41: 3GPP TS38.470 NR F1 Interface Overview Specification Version 16.0.0
Non-Patent Literature 42: 3GPP TS38.473 NR F1AP Version 16.0.0
Non-Patent Literature 43: 3GPP R2-2111638 Introduction of efficient SCG activation/deactivation

### SUMMARY

A second radio communication device includes, a receiver configured to receive a Radio Resource Control (RRC) message from a first radio communication device, and a controller configured to, when the RRC message includes a first parameter and a second parameter, control to perform processing according to the second parameter after performing processing of resuming a radio bearer in a suspended state.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating a configuration example of a communication system 10.

FIG. 2 is a diagram illustrating a configuration example of a base station device 200.

FIG. 3 is a diagram illustrating a configuration example of the terminal device 100.

FIG. 4 is a diagram illustrating an example of a U-Plane protocol stack in a situation where the core network 300 is 5GC.

FIG. 5 is a diagram illustrating an example of a C-Plane protocol stack in a situation where the core network 300 is 5GC.

FIG. 6 is a diagram illustrating an example of the message format of RRCReconfiguration.

FIG. 7 is a diagram illustrating an example of the configuration of cell groups of the communication system 10.

FIGS. 8A to 8D each assume a state in which SRB1 and SRB2 are established as C-Plane interface between the terminal device 100 and the base station device 200-1.

FIG. 9 is a diagram illustrating an example of reconfiguration with sync.

FIG. 10 is a diagram illustrating an example in which an end marker control PDU is transmitted.

FIG. 11 is a diagram illustrating an example of a sequence in which the state of the SCG changes to inactive state.

FIG. 12 is a diagram illustrating an example of a sequence in which the terminal device 100 in SCG deactivation receives an RRC reconfiguration message.

FIG. 13 is a diagram illustrating an example of a sequence of UL data arrival in SCG deactivation.

FIGS. 14A and 14B are diagrams illustrating an example of a transition from the RRC connection mode to the RRC inactive mode, and from the RRC inactive mode to the RRC connection mode.

FIG. 15 is a diagram illustrating an example of a sequence for receiving a first RRC message when the radio bearers at least on the SCG side of the terminal device 100 are in a suspended state (the radio bearers are suspended).

### DESCRIPTION OF EMBODIMENTS

The procedure by which a base station device deactivates or activates the secondary cell group of a terminal device has not been determined as standard specifications.

For example, “3GPP R2-2111683 Introduction of Efficient SCG Activation/Deactivation” describes a proposed procedure for a base station device to deactivate or activate the secondary cell group of a terminal device. However, according to “3GPP R2-2111683 Introduction of Efficient SCG Activation/Deactivation”, when a terminal device whose radio bearers are in a suspended state receives a message including a reconfiguration with sync parameter from a base station device, transmission using the secondary cell group will be resumed even if the same message includes a parameter indicating to deactivate the secondary cell group. This results in unnecessary power consumption.

One disclosure allows for the limitation of power consumption of a terminal device in activating communication between the terminal device for which the secondary cell group is in an inactive state and a secondary base station device in MR-DC.

Referring to the drawings, the present embodiment is described in detail below. The issues and examples in this specification are merely examples, and do not limit the scope of right in this application. In particular, the technologies of the present application are applicable to different expressions that are technically equivalent, and the scope of rights is not limited.

### Configuration Example of Communication System 10

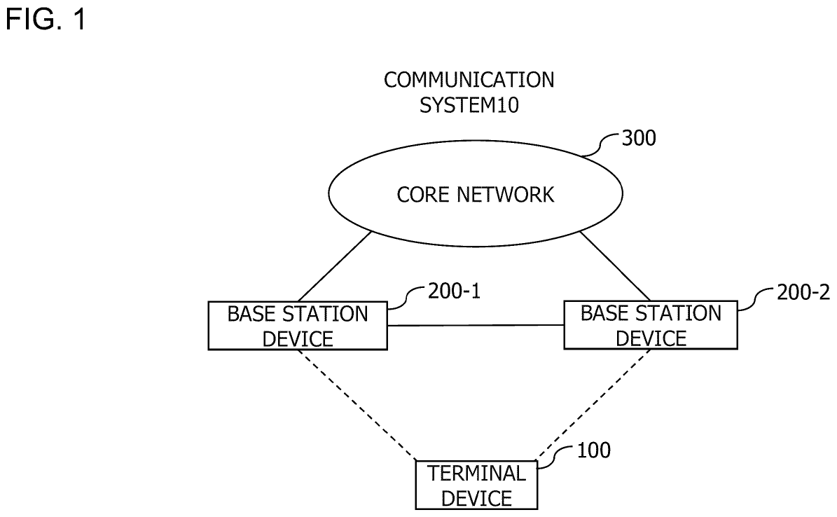

FIG. 1 is a diagram illustrating a configuration example of a communication system 10. The communication system 10 includes a terminal device 100, base station devices 200-1 and 200-2, and a core network 300. The communication system 10 may be a radio communication system in which the terminal device 100 communicates with the base station device 200-1 or the base station device 200-2, or may be a radio communication system in which the terminal device 100 communicates with the base station device 200-1 and the base station device 200-2 using MR-DC. When communication is performed using MR-DC, the base station device 200-1 may be a master base station device, and the base station device 200-2 may be a secondary base station device, for example. Hereinafter, the master base station device may be referred to as a master node (MN), and the secondary base station device may be referred to as a secondary node (SN).

The terminal device 100 is wirelessly connected to one or both of the base station device 200-1 and the base station device 200-2 and performs radio communication. The Radio Access Technology (RAT) that provides radio connection may be E-UTRA or NR, for example. The terminal device 100 is a tablet terminal or a smartphone that supports either E-UTRA or NR or both.

The base station devices 200-1 and 200-2 (hereinafter may be referred to as base station devices 200) are communication devices that are wirelessly connected to the terminal device 100 and perform radio communication. The base station devices 200-1 and 200-2 may be connected to each other by wire and communicate with each other, for example. The base station devices 200 may be connected to the core network 300 and communicate with the core network 300 by wire, for example. Each base station device 200 may be a base station device of either an eNodeB that provides E-UTRA as the RAT or a gNodeB that provides NR as the RAT.

The core network 300 is a network that supports a certain generation. The core network 300 may be a core network supporting 5G (hereinafter may be referred to as 5GC) or an Evolved Packet Core (EPC) supporting 4G.

Details of MR-DC implemented in the communication system 10 will be described below.

### Configuration Example of Base Station Device 200

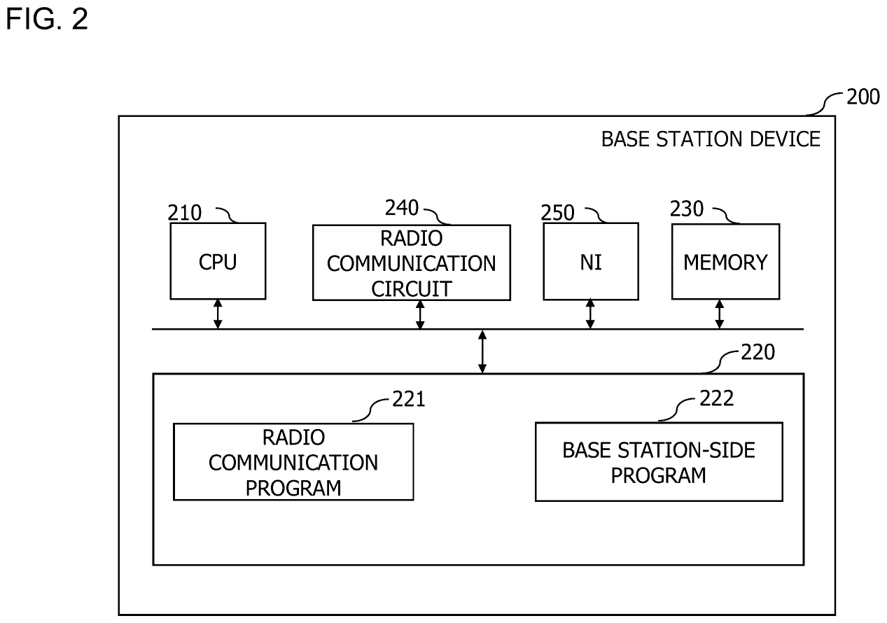

FIG. 2 is a diagram illustrating a configuration example of a base station device 200. The base station device 200 is a communication device or a relay device that includes a central processing unit (CPU) 210, a storage 220, a memory 230, a radio communication circuit 240, and a network interface 250.

The storage 220 is an auxiliary storage device, such as a flash memory, a hard disk drive (HDD), or a solid-state drive (SSD), that stores programs and data. The storage 220 stores therein a radio communication program 221, and a base station-side program 222.

The memory 230 is an area into which the programs stored in the storage 220 are loaded. The memory 230 may also be used as an area for programs to store data.

The radio communication circuit 240 is a circuit that wirelessly connects to the terminal device 100 and communicates with the terminal device 100. For example, the base station device 200 receives signals transmitted from the terminal device 100 and transmits signals to the terminal device 100 via the radio communication circuit 240.

A network interface (NI) 250 may be a communication device that connects to another base station device 200 and performs inter-base station communication, for example. Also, the NI 250 may be a communication device that connects to the core network 300 (a communication device that forms the core network 300) and communicates with the core network 300, for example. The NI 250 may be a Network Interface Card (NIC), for example. The base station device 200 receives signals from other communication devices and transmits signals to other communication devices via the NI 250.

The CPU 210 is a processor that loads a program stored in the storage 220 into the memory 230, executes the loaded program, constructs each unit, and implements each processing.

The CPU 210 performs radio communication processing by executing the radio communication program 221. The radio communication processing may be processing involving radio connection with the terminal device 100, radio communication with the terminal device 100, and relaying the communication between the terminal device 100 and other communication devices.

The CPU 210 executes the base station-side program 222 to construct a second transmission unit, a second reception unit, and a second processing unit, and performs base station-side processing. When the base station device 200 communicates with the terminal device 100 using MR-DC, the base station-side processing may include MR-DC master node processing and MR-DC secondary node processing. In this case, the MR-DC master node processing is processing for controlling the master node side in the MR-DC, and the MR-DC secondary node processing is processing for controlling the secondary node side in the MR-DC. The base station device 200 performs communication corresponding to each type of MR-DC, which will be described below, in MR-DC master node processing and MR-DC secondary node processing.

### Configuration Example of Terminal Device 100

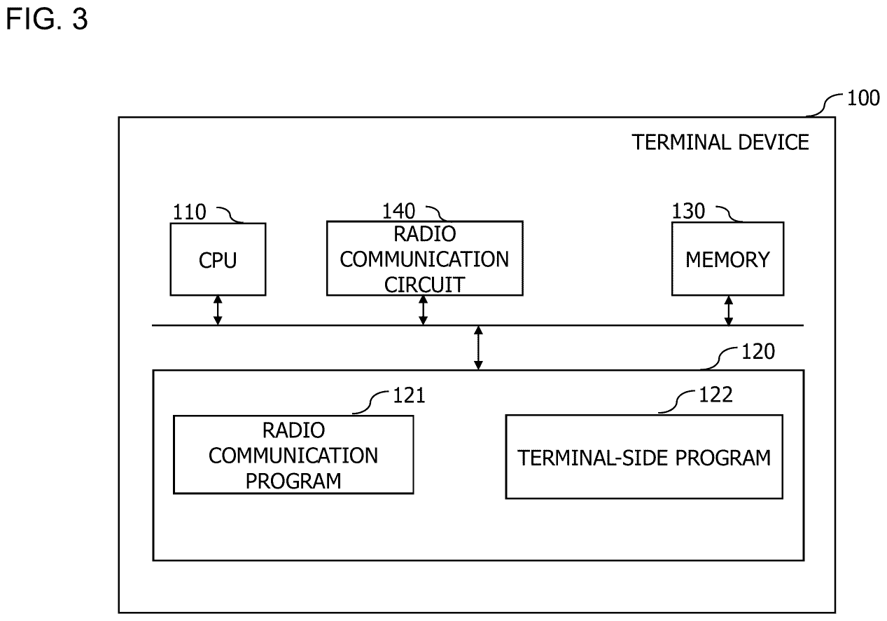

FIG. 3 is a diagram illustrating a configuration example of the terminal device 100. The terminal device 100 is a communication device, which includes a CPU 110, a storage 120, a memory 130, and a radio communication circuit 140.

The storage 120 is an auxiliary storage device, such as a flash memory, HDD, or SSD, that stores therein programs and data. The storage 120 stores therein a terminal-side radio communication program 121 and a terminal-side program 122.

The memory 130 is an area into which programs stored in the storage 120 are loaded. The memory 130 may also be used as an area for programs to store data.

The radio communication circuit 140 is a circuit that wirelessly connects to and communicates with the base station device 200. For example, the terminal device 100 receives signals transmitted from the base station device 200 and transmits signals to the base station device 200 via the radio communication circuit 140. The radio communication circuit 140 may be a network card that supports radio connection, for example.

The CPU 110 is a processor that loads a program stored in the storage 120 into the memory 130, executes the loaded program, constructs each unit, and implements each processing.

The CPU 110 performs terminal-side radio communication processing by executing the terminal-side radio communication program 121. The terminal-side radio communication processing is processing involving radio connection with the base station device 200, radio communication with the base station device 200, and relaying the communication between the base station device 200 and other communication devices.

The CPU 110 executes the terminal-side program 122 to construct a transmission unit, a reception unit, and a processing unit, and performs terminal-side processing. When the terminal device 100 communicates with the base station device 200 using MR-DC, the terminal-side processing may include terminal-side MR-DC processing. In this case, the terminal-side MR-DC processing is processing for controlling communication in MR-DC. In the terminal side MR-DC processing, the terminal device 100 performs communication corresponding to each type of MR-DC, which will be described below.

### Protocol Stack

Examples of protocol stacks of the communication system 10 are now described. A representation in a hierarchical structure of a series of protocols for transmitting and receiving data in the communication system 10 is referred to as a protocol stack. In the following example, a situation is described where the base station device 200 is an eNB or a gNB, and the core network 300 is EPC or 5GC. Also, the terminal device 100 (UE: User Equipment) supports either or both of E-UTRA and NR.

The protocol stacks of User Plane (U-Plane) and Control Plane (C-Plane) are described below. U-Plane may represent data signals (messages) of user data that are transmitted and received, for example. C-Plane may represent control signals (messages) transmitted and received in communication, for example.

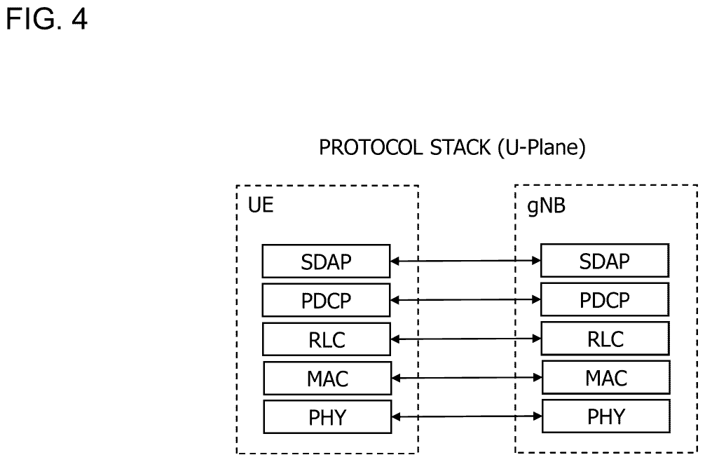

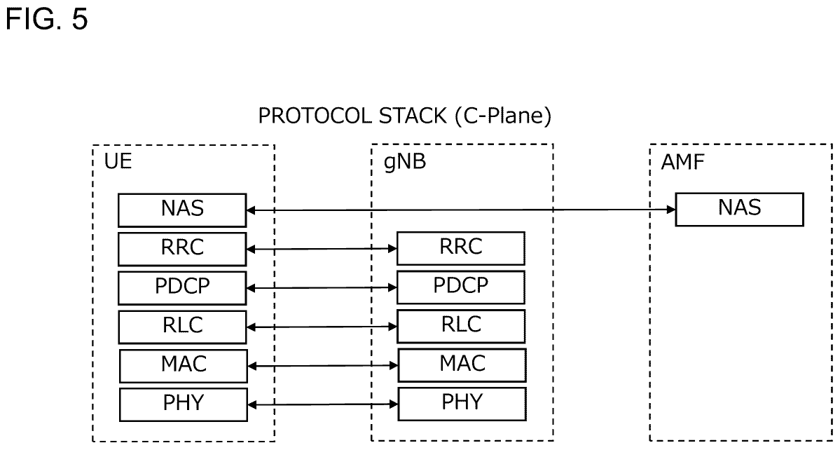

FIG. 4 is a diagram illustrating an example of a U-Plane protocol stack in a situation where the core network 300 is 5GC. FIG. 5 is a diagram illustrating an example of a C-Plane protocol stack in a situation where the core network 300 is 5GC. In FIGS. 4 and 5, SDAP, PDCP, RLC, MAC, PHY, NAS, and RRC represent the names of the layers. Hereinafter, SDAP, PDCP, RLC, MAC, PHY, NAS, and RRC may also be referred to as SDAP sublayer, PDCP sublayer, RLC sublayer, MAC sublayer, PHY sublayer, NAS sublayer, and RRC sublayer, or SDAP layer, PDCP layer, RLC layer, MAC layer, PHY layer, NAS layer, and RRC layer, respectively. Furthermore, SDAP, PDCP, RLC, MAC, PHY, NAS, and RRC may also be referred to as SDAP entity, PDCP entity, RLC entity, MAC entity, PHY entity, NAS entity, and RRC entity, respectively. The U-Plane protocol stack in a situation where the core network 300 is EPC is a protocol stack that does not include the SDAP in FIG. 4, that is, a protocol stack consisting of PDCP, RLC, MAC, and PHY. Also, the C-Plane protocol stack in a situation where the core network 300 is EPC is a protocol stack in which NAS is in MME, unlike FIG. 5 in which NAS is in AMF.

Some functions within each layer may remain common regardless of whether the RAT is E-UTRA or NR, while others may vary depending on whether the RAT is E-UTRA or NR. In the following description, unless E-UTRA or NR is specified, the functions in each layer are common functions to both E-UTRA and NR.

In FIG. 4, U-Plane includes Service Data Adaptation Protocol (SDAP), Packet Data Convergence Protocol (PDCP), Radio Link Control (RLC), Medium Access Control (MAC), and PHYsical (PHY), and terminates at the terminal device 100 (UE) and the base station device 200 (gNB).

PHY is a radio physical layer and uses physical channels to transmit control information and data between the terminal device 100 and the base station device 200. The direction from the base station device 200 to the terminal device may be referred to as downlink (down, DL), and the direction from the terminal device 100 to the base station device may be referred to as uplink (up, UL). In the terminal device 100 and the base station device 200, PHY is connected to MAC, which is an upper layer, via transport channels, and data moves between the PHY and the MAC via the transport channels.

MAC is a medium access control layer and performs mapping between transport channels and logical channels (LCH), multiplexing/demultiplexing of MAC SDUs, scheduling reports, error correction through Hybrid Automatic Repeat reQuest (HARQ), priority control, and the like. In the terminal device 100 and the base station device 200, MAC is connected to RLC, which is an upper layer, via logical channels. Data moves between the MAC and the RLC via logical channels.

A Service Data Unit (SDU) refers to data that is passed from or to upper layers in each sublayer. A Protocol Data Unit (PDU) refers to data passed from or to lower sublayers in each sublayer.

In RLC, PDCP, and SDAP, there are PDUs for control, which may be referred to as control PDUs. The other PDUs may be referred to as data PDUs to distinguish them from control PDUs.

RLC is the radio link control layer and has three modes of Transparent Mode (TM), Unacknowledged Mode (UM), and Acknowledged Mode (AM). RLC may perform transfer of PDUs of the upper layer PDCP, assignment of sequence numbers (in UM and AM), division (in UM and AM) and re-division (in AM) of data on the transmission side, perform reassembling of SDUs (in UM and AM), duplicate detection (in AM), RLC SDU discard (in UM and AM) on the reception side, and perform RLC re-establishment on the transmission side and the reception side, for example. For E-UTRA RLC, other functions include data combining on the transmission side, and reordering and in-order delivery on the reception side.

PDCP is a packet data convergence protocol layer and performs U-Plane and C-Plane data transfer, PDCP sequence number management, header compression/decompression, encryption/decryption, integrity protection/integrity verification, timer-based SDU discard, routing for split bearers, reordering, and in-order delivery, for example. Additionally, E-UTRA PDCP may have functions such as timer-based SDU discard, reordering, and in-order delivery only for split bearers.

SDAP is a service data adaptation protocol layer and performs mapping between Quality of service (QOS) flows and Data Radio Bearers (DRBs) and marking of QoS flow identifier (QFI) in downlink (DL) packets and uplink (UL) packets, for example.

Upper layers of U-Plane may include Internet Protocol (IP), Transmission Control Protocol (TCP), User Datagram Protocol (UDP), Ethernet (registered trademark), and application layers, for example. Layers such as IP, TCP, UDP, and Ethernet may be included in the PDU layer. Also, the IP Multimedia Subsystem (IMS) may be included in the application layers.

In FIG. 5, the C-Plane of Access Stratum (AS) includes PDCP, RLC, MAC, PHY, and Radio Resource Control (RRC) and terminates at the terminal device 100 and the base station device 200. The C-Plane of Non Access Stratum (NAS) includes NAS and terminates between the terminal device 100 and Access and Mobility management Function (AMF), which is a device of the core network 300. The PDCP, RLC, MAC, and PHY are the same as U-Plane.

RRC may perform broadcasting of system information (SI) relating to Access Stratum and NAS, paging, establishment/maintenance/release of RRC connection between the terminal device 100 and the base station device 200, addition/modification/release of carrier aggregation (CA), addition/modification/release of dual connectivity (DC), security function including security key management, establishment/configuration/maintenance/release of Signaling Radio Bearer (SRB) and data radio bearer (DRB), mobility function, QoS management function, terminal device measurement report and reporting control, radio link failure (RLF) detection and recovery, NAS message transfer, and the like.

The NAS may perform authentication, mobility management, and security control, for example.

When the device of the core network 300 is EPC (Evolved Packet Core), there is no SDAP in the U-Plane. When the device of the core network 300 is EPC, the NAS of the C-Plane terminates between the terminal device 100 and Mobility Management Entity (MME), which is a device of the core network 300.

### Channel

The channels used in the communication system 10 are now described. Examples of channels corresponding to NR are described below, but the channels used are not limited to the following. Also, channels with the same name may be used in RATs other than NR, such as E-UTRA, for the same or similar purposes.

### 1. Physical Channel

Physical Broadcast CHannel (PBCH) is a channel used to transmit broadcast information from the base station device 200 to the terminal device 100.

Physical Downlink Control CHannel (PDCCH) is a channel used to transmit Downlink Control Information (DCI) from the base station device 200 to the terminal device 100, for example.

Physical Downlink Shared CHannel (PDSCH) is a channel used to transmit data from upper layers from the base station device 200 to the terminal device 100, for example.

Physical Uplink Control CHannel (PUCCH) is a channel used to transmit Uplink Control Information (UCI) from the terminal device 100 to the base station device 200, for example.

Physical Uplink Shared CHannel (PUSCH) is a channel used to transmit data from upper layers from the terminal device 100 to the base station device 200, for example.

Physical Random Access CHannel (PRACH) is a channel used to transmit a random access preamble from the terminal device 100 to the base station device 200, for example.

### 2. Transport Channel

Broadcast Channel (BCH) is mapped to PBCH, which is a physical channel.

Downlink Shared Channel (DL-SCH) is mapped to PDSCH, which is a physical channel.

Paging Channel (PCH) is mapped to PDSCH, which is a physical channel.

Downlink Shared Channel (UL-SCH) is mapped to PUSCH, which is a physical channel.

Random Access Channel(s) (RACH) is mapped to PRACH, which is a physical channel.

### 3. Logical Channel

Broadcast Control Channel (BCCH) is a downlink channel for broadcasting system information and is mapped to the BCH transport channel.

Paging Control Channel (PCCH) is a downlink channel for carrying paging messages, and is mapped to the PCH transport channel.

Common Control Channel (CCCH) is a channel for transmitting control information (such as RRC messages) between the terminal device 100 and the base station device 200, and a channel used for the terminal device 100 that does not maintain (has) RRC connection with the base station device 200. CCCH is mapped to the DL-SCH transport channel for downlink, and is mapped to the UL-SCH transport channel for uplink.

Dedicated Control Channel (DCCH) is a point-to-point bidirectional channel that transmits dedicated control information (such as RRC messages) between the terminal device 100 and the base station device 200, is used for the terminal device 100 that has RRC connection with the base station device 200. DCCH is mapped to the DL-SCH transport channel for downlink, and is mapped to the UL-SCH transport channel for uplink.

Dedicated Transport Channel (DTCH) is a bidirectional channel dedicated to point-to-point terminals and transmits user information (user data). DTCH is mapped to the DL-SCH transport channel for downlink, and is mapped to the UL-SCH transport channel for uplink.

### RRC Message

The RRC message is now described. An RRC message is a message that includes information needed for communication in the cell, and includes a Master Information Block (MIB), a system information block, and the like. Parameters included in an RRC message may be referred to as fields or Information Elements (IEs).

RRC messages also include a message regarding RRC connection establishment. In the case of NR, examples of messages regarding RRC connection establishment include an RRC setup request message (RRCSetupRequest), an RRC setup message (RRCSetup), and an RRC setup completion message (RRCSetupComplete). Examples of messages regarding RRC connection establishment for E-UTRA include an RRC connection setup request message (RRCConnectionSetupRequest), an RRC connection setup message (RRCConnectionSetup), and an RRC connection setup complete message (RRCConnectionSetupComplete).

RRC messages also include a message regarding Access Stratum (AS) security initial activation. Examples of messages regarding AS security initial activation include a security mode command message (SecurityModeCommand).

RRC messages also include messages regarding RRC connection reconfiguration. In the case of NR, examples of the messages regarding RRC connection reconfiguration include an RRC reconfiguration message (RRCReconfiguration) and an RRC reconfiguration complete message (RRCReconfigurationComplete). Examples of messages regarding RRC connection reconfiguration for E-UTRA include an RRC connection reconfiguration message (RRCConnectionReconfiguration) and an RRC connection reconfiguration complete message (RRCConnectionReconfigurationComplete).

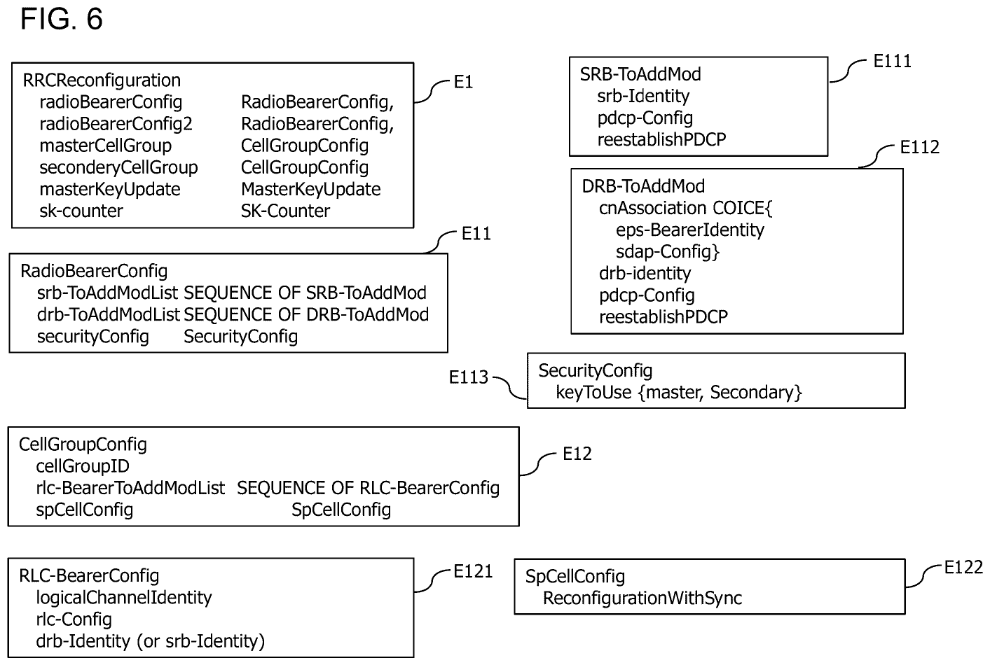

FIG. 6 is a diagram illustrating an example of the message format of RRCReconfiguration. Format E1 includes RRC Reconfiguration parameters.

RRC Reconfiguration includes, as parameters, radioBearerConfig, radioBearerConfig2, masterCellGroup, secondaryCellGroup, masterKeyUpdate, and sk-counter.
radioBearerConfig and radioBearerConfig2 are configurations relating to MN-terminated bearers or SN-terminated bearers, and may include SRB configuration, DRB configuration, security configuration, and the like. The SRB configuration (DRB configuration) may include an SRB identifier (DRB identifier), parameters instructing PDCP configuration and PDCP re-establishment, and the like. The security configuration includes the parameter indicating whether to use a master key or a secondary key (keyToUse).
masterCellGroup and secondaryCellGroup are MCG configuration and SCG configuration, respectively, and may include a cell group identifier, RLC bearer configuration, SpCell configuration, and the like. The RLC bearer configuration may include a logical channel identifier, RLC configuration, a radio bearer identifier (SRB identifier or DRB identifier) associated with the RLC bearer, and the like. The SpCell configuration may include information needed for reconfiguration with sync.
masterKeyUpdate includes information needed to update the master key.
sk-counter includes information needed for secondary key generation.
Format E11 is a diagram illustrating examples of parameters of RadioBearerConfig included in RRCReconfiguration.
Format E12 is a diagram illustrating examples of parameters of CellGroupConfig included in RRCReconfiguration.
Format E111 is a diagram illustrating examples of SRB-ToAddMod parameters included in RadioBearerConfig.
Format E112 is a diagram illustrating examples of DRB-ToAddMod parameters included in RadioBearerConfig.
Format E113 is a diagram illustrating examples of SecurityConig parameters included in RadioBearerConfig.
Format E121 is a diagram illustrating examples of parameters of RLC-BearerConfig included in CellGroupConfig.
Format E122 is a diagram illustrating examples of parameters of SpCellConfig included in CellGroupConfig.

Messages regarding RRC connection reconfiguration may perform establishment, configuration, modification, release, and reconfiguration with sync of radio bearers, cell groups, and establishment, configuration, modification, and release of measurement information.

RRC messages may further include messages regarding re-establishment of RRC connection, messages regarding release and suspension of RRC connection, messages regarding resumption of RRC connection, messages regarding terminal device capabilities, messages regarding terminal information, MCG failure information, and messages regarding SCG failure information.

Also, in MR-DC, when the master node is an eNB, the eNB may perform configuration on the terminal device 100 regarding NR by causing the E-UTRA RRC message to include, as a container, the NR RRC message and parameters received from the gNB, which is the secondary node, and transmitting it to the terminal device 100. The terminal device 100 may also cause an E-UTRA RRC message to include, as a container, a completion message for configuration regarding NR and transmit it to the eNB, which is the master node.

Also, in MR-DC, when the master node is a gNB, the gNB may perform configuration on the terminal device 100 regarding E-UTRA by causing an NR RRC message to include the E-UTRA RRC message and parameters received from the eNB, which is the secondary node, as a container and transmitting it to the terminal device 100. The terminal device 100 may also cause an NR RRC message to include a completion message for configuration regarding E-UTRA as a container and transmit it to the gNB, which is the master node.

### Radio Bearer

Examples of radio bearers of the communication system 10 are now described.

### 1. Signaling Radio Bearer

Signaling Radio Bearer (SRB) is a radio bearer for transmitting RRC messages and NAS messages.

SRB0 is a radio bearer for RRC messages that use the Common Control CHannel (CCCH) logical channel.

SRB1 is a radio bearer for RRC messages and NAS messages that use the Dedicated Control CHannel (DCCH) logical channel before SRB2, which is described below, is established.

SRB2 is a radio bearer for NAS messages and RRC messages that include logged measurement information, and uses the Dedicated Control CHannel (DCCH) logical channel. The priority of SRB2 is lower than SRB1, and may be configured by the base station device 200 after AS security is activated.

SRB3 is a radio bearer for RRC messages used when EN-DC, NGEN-DC, or NR-DC is configured in the terminal device 100, and uses the Dedicated Control CHannel (DCCH) logical channel. EN-DC, NGEN-DC, and NR-DC are types of MR-DC, and details of the types of MR-DC will be described below.

### 2. Data Radio Bearer

Data Radio Bearer (DRB) is a radio bearer for transmitting user data.

### Protocol Configuration of SRB and DRB

SRB1 and SRB2 include one PDCP and one or more RLC bearers. An RLC bearer includes RLC and MAC logical channels. It is assumed that MAC exists for each cell group described below. The mode of RCL is AM.

SRB3 includes one PDCP and one RLC bearer. The RLC mode is AM.

A DRB includes one PDCP and one or more RLC bearers. The RLC mode is UM or AM. A DRB may be referred to as UM DRB when RLC is UM, and as AM DRB when RLC is AM. A DRB is associated with one SDAP when the core network 300 is 5GC (core supporting 5G), and is associated with one EPS bearer (or EPS bearer identity) when the core network 300 is EPC.

5GC is a core network standardized for 5G and is described in 3GPP standards such as TS 23.501 and TS 23.502, for example.

EPC is a core network standardized for 4G and is described in 3GPP standards such as TS 23.401 and TS 23.402, for example.

### Cell Group

Cell Group (CG) represents the configuration of cells in MR-DC. In MR-DC, cell groups are classified as a Master Cell Group (MCG) or Secondary Cell Group (SCG).

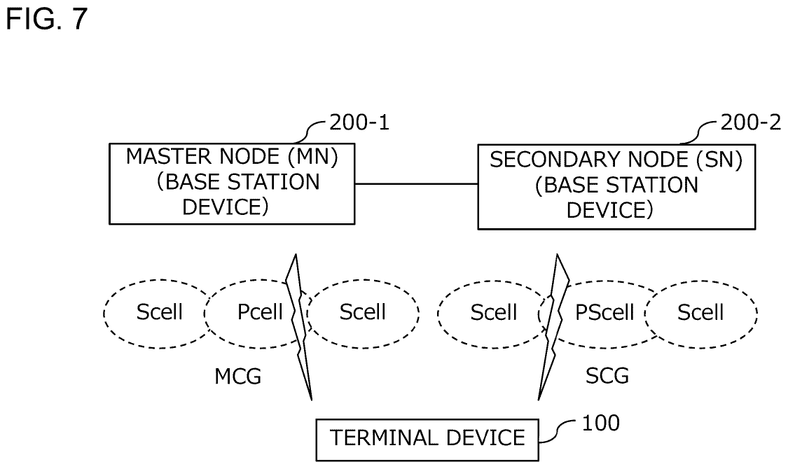

FIG. 7 is a diagram illustrating an example of the configuration of cell groups of the communication system 10. In FIG. 6, the master node (MN) is the base station device 200-1, and the secondary node (SN) is the base station device 200-2. The master node is the base station device 200 that provides C-Plane connection to the core network 300 in MR-DC. The secondary node is the base station device 200 that does not provide C-Plane to the core network 300 and provides additional radio resources to the terminal device 100 in MR-DC.

CG includes one Special Cell (SpCell), or includes one SpCell and one or more secondary cells (SCell).

SpCell in MCG may be referred to as a primary cell (PCell). Also, SpCell in SCG may be referred to as a primary SCG cell (PSCell).

In FIG. 7, the MCG includes one PCell and two SCells. Also, in FIG. 7, the SCG includes one PSCell and two SCells.

The MCG may be a CG when MR-DC is not configured, or a CG belonging to the master node when MR-DC is configured.

The SCG is a CG belonging to the secondary node in MR-DC.

The PCell is a cell that operates on the primary frequency in the MCG and is used by the terminal device 100 for initial connection establishment procedures, connection re-establishment procedures, and the like. Connection establishment/re-establishment procedures include a random access procedure.

The PSCell is a cell used in the SCG for a random access procedure when the terminal device 100 performs reconfiguration with sync.

The SCell is a cell that provides additional radio resources in addition to the SpCell to the terminal device 100 for which carrier aggregation is configured.

### Types of MR-DC

The types of MR-DC are now described. MR-DC is classified into four types depending on the type (supporting generation) of the base station devices 200 of the master node and the secondary node and the type (supporting generation) of the core network 300.

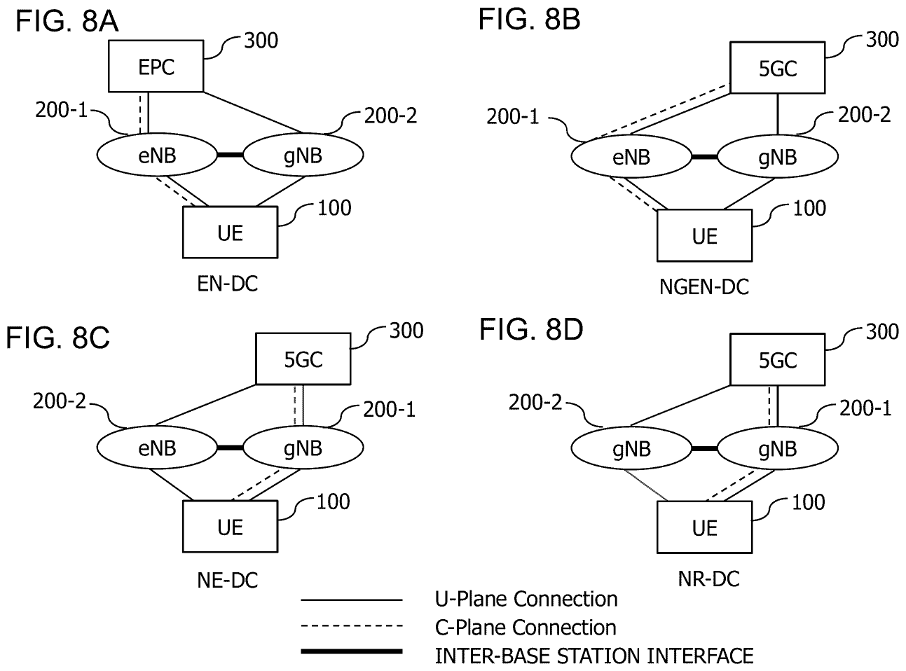

FIGS. 8A to 8D are diagrams illustrating examples of MR-DC types. Each type of MR-DC is described below. In FIGS. 8A to 8D, the master node is the base station device 200-1, and the secondary node is the base station device 200-2.

FIG. 8A is a diagram illustrating an example of EN-DC. E-UTRA-NR DC (EN-DC) is MR-DC including eNB, which is a base station device 200 of E-UTRA, as the master node, gNB, which is a base station device 200 of NR, as the secondary node, and EPC as the core network 300.

FIG. 8B is a diagram illustrating an example of NGEN-DC. NG-RAN E-UTRA-NR DC (NGEN-DC) is MR-DC including eNB as the master node, gNB as the secondary node, and 5GC as the core network 300.

FIG. 8C is a diagram illustrating an example of NE-DC. NR-E-UTRA DC (NE-DC) is MR-DC including gNB as the master node, eNB as the secondary node, and 5GC as the core network 300.

FIG. 8D is a diagram illustrating an example of NR-DC. NR-NR DC (NR-DC) is MR-DC including gNB as the master node, a different gNB as the secondary node, and 5GC as the core network 300.

EN-DC and NGEN-DC may also be referred to as (NG) EN-DC. The secondary node of EN-DC may be referred to as en-gNB. The master node of NGEN-DC may be referred to as ng-eNB.

FIGS. 8A to 8D each assume a state in which SRB1 and SRB2 are established as C-Plane interface between the terminal device 100 and the base station device 200-1. When split SRB1, split SRB2, or SRB3 is established, some C-Plane messages may be transmitted and received between the secondary node and the terminal device 100. Some of the C-Plane messages received by the secondary node are transmitted to the master node via the inter-base station interface. Also, some of the C-Plane messages transmitted from the secondary node are transmitted from the master node to the secondary node via the inter-base station interface.

### MR-DC Bearer Type

Bearer types in MR-DC are now described. Hereinafter, a configuration in which PDCP terminates at the master node and the master node side has PDCP may be referred to as MN-terminated. A configuration in which PDCP terminates at the secondary node and the secondary node side has PDCP may be referred to as SN-terminated. Bearer types are classified into the following six types.
1) MN-terminated MCG bearer with RLC bearer on the MCG side
2) MN-terminated Split bearer with RLC bearer in both MCG and SCG
3) MN-terminated SCG bearer with RLC bearer on the SCG side
4) SN-terminated MCG bearer with RLC bearer on the MCG side
5) SN-terminated Split bearer with RLC in both MCG and SCG
6) SN-terminated SCG bearer with RLC bearer on the SCG side A DRB has one of the six bearer types described above.

SRB1 and SRB2 may be MN-terminated MCG bearers or MN-terminated Split bearers. When SRB1 and SRB2 are MN-terminated Split bearers, they may be referred to as splitSBR1 and splitSBR2, respectively.

SBR3 is an SN-terminated SCG bearer.

Also, Primary Path is configured for a Split bearer. Primary Path indicates the base station device 200 to which the terminal device 100 transmits data (preferentially) in the initial state. Primary Path is specified by the cell group (MCG, SCG) and LCH. The terminal device 100 transmits data to the base station device 200 of Primary Path unless the amount of uplink transmission data exceeds a threshold. The terminal device 100 may transmit data to either base station device 200 when the threshold is exceeded.

The security key used in PDCP for MN-Terminated (master key) differs from that used for SN-Terminated (secondary key).

### Reconfiguration With Sync (Handover)

Reconfiguration with sync (handover) is now described. Reconfiguration with sync represents a procedure performed by the terminal device 100 when the base station device 200 causes an RRC reconfiguration message (RRCReconfiguration) that is to be transmitted to the terminal device 100 to include a parameter indicating that reconfiguration with sync is to be performed (reconfigurationWithSync: hereinafter may be referred to as reconfiguration with sync parameter).

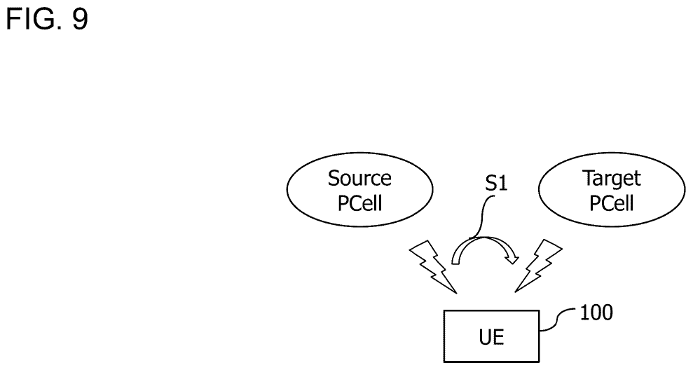

FIG. 9 is a diagram illustrating an example of reconfiguration with sync. The terminal device (UE) 100 changes the current source PCell to the target PCell (S1). Reconfiguration with sync parameters are separately included under parameters for MCG configuration (hereinafter may be referred to as MCG configuration parameters) and under parameters for SCG configuration (hereinafter may be referred to as SCG configuration parameters). In other words, it indicates reconfiguration with sync of MCG when included under MCG configuration parameters, and it indicates SCG reconfiguration with sync when included under SCG configuration parameters.

Reconfiguration with sync is a procedure in which the terminal device 100 changes the PCell and PSCell, and includes operations such as random access to the new (changed, target) PCell and PSCell, MAC reset, and PDCP data recovery (for AM DRB).

Additionally, reconfiguration with sync may involve a change of the security key. In this case, PDCP re-establishment is performed in addition to the above.

When the security key is changed, a new key is generated at the RRC of the terminal device 100 and the PDCP is re-established, so that the new key is applied to the PDCP.

### Qos Flow Remapping in SDAP

In the terminal device 100, when a DRB to which a certain QoS flow is associated (mapped) is changed, an end marker control PDU is transmitted to the DRB before change.

A QOS flow is a Service Data Flow (SDF) with the same QoS requirement and is identified by a QoS flow identifier (QFI). SDFs may be an IP flow, an Ethernet flow, and the like, and vary depending on the upper layers.

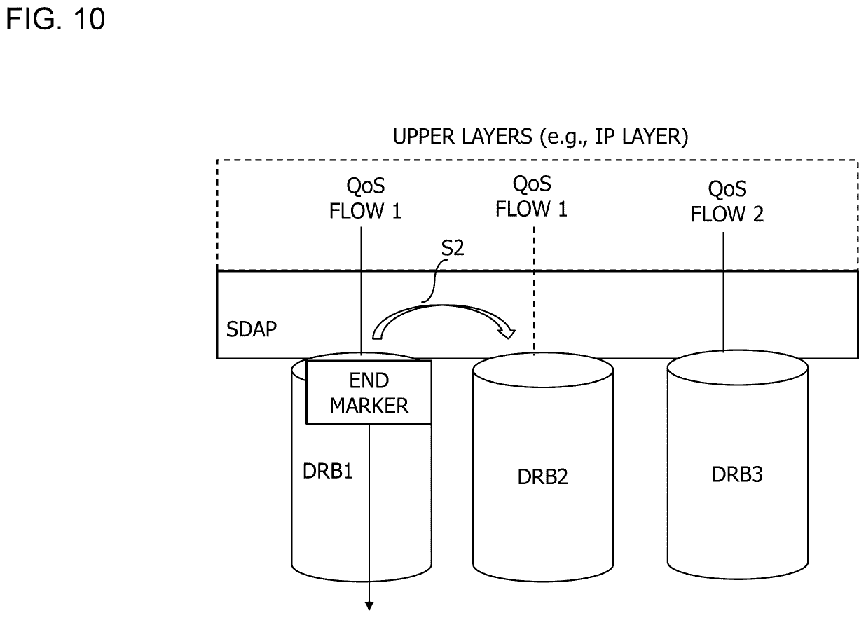

FIG. 10 is a diagram illustrating an example in which an end marker control PDU is transmitted. For example, in the terminal device 100, the DRB to which Qos flow 1 is mapped is changed from DRB1 to DRB2 (S2). At this time, the terminal device 100 transmits the data of QoS flow 1 that is retained before the change is instructed using DRB1 before the change. Then, the terminal device 100 transmits, through DRB1, an end marker control PDU (end marker M1) indicating that it is the last time to transmit data of QoS flow 1 through DRB1. This allows the base station device 200 to identify that, from that time forward, data of QoS flow 1 will not be transmitted using DRB1 before change. The mapping between a QoS flow and a DRB may be performed using parameters included in the RRC reconfiguration message or using the header information included in a downlink SDAP data PDU. The latter is called reflective mapping.

### RRC State (Mode)

The RRC state of the terminal device 100 indicates the state regarding the RRC connection of the terminal device 100. A state in which RRC connection with the base station device 200 is not established may be referred to as RRC idle mode (RRC_IDLE). A state in which RRC connection with the base station device 200 is established may be referred to as RRC connection mode (RRC_CONNECTED). A state in which RRC connection with the base station device 200 is suspended may be referred to as RRC inactive mode (RRC_INACTIVE). When the core network 300 is EPC, a state in which the RRC connection with the base station device 200 is suspended does not need to be referred to as RRC inactive mode. It may be referred to as another name, such as RRC suspend.

The transition from the RRC idle mode to the RRC connection mode may be performed by transmitting and receiving messages regarding establishment of RRC connection between the terminal device 100 and the base station device 200. For example, in NR, the terminal device 100 may transition to the RRC connection mode by sending an RRC setup request message to the base station device 200 and receiving an RRC setup message from the base station device 200 in response. The RRC setup request message and the RRC setup message may be transmitted and received using the CCCH logical channel. The cell used to transmit and receive the RRC setup request message and the RRC setup message may be the PCell.

The terminal device 100 that has transitioned to the RRC connection mode can transmit and receive user data (such as IP packets and Ethernet frames) by further receiving from the base station device 200 a message regarding the initial activation of AS security and a message regarding re-establishment of RRC connection, and performing configuration in accordance with the messages. Also, carrier aggregation and MR-DC may be configured by a message regarding re-establishment of RRC connection. Messages regarding the initial activation of AS security and messages regarding re-establishment of RRC connection may be received using the DCCH logical channel.

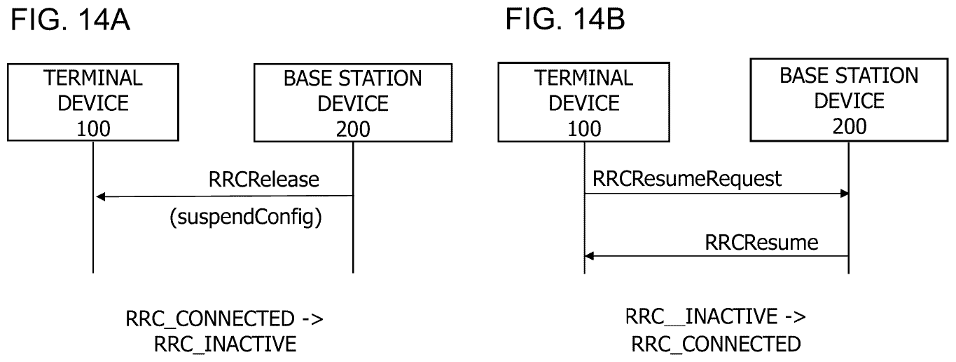

The transition from the RRC connection mode to the RRC inactive mode may be performed by the terminal device 100 receiving from the base station device 200 a message regarding release of RRC connection and including parameters regarding the suspend configuration of RRC connection. FIG. 14A is a diagram illustrating a transition procedure from the RRC connection mode to the RRC inactive mode in a situation where the base station device 200 is a gNB (the master node is a gNB when MR-DC is used) and the core network 300 is 5GC. The base station device 200 transmits to the terminal device 100 a message (RRCRelease) regarding release of the RRC connection, including a parameter (suspendConfig) regarding the suspend configuration of the RRC connection. The terminal device 100 performs processing according to the received RRCRelease message, thereby transitioning to the RRC inactive mode. RRCRelease may be transmitted using the DCCH logical channel.

When transitioning to the RRC inactive mode, the terminal device 100 may perform processing including saving the UE inactive AS context and suspending the radio bearers other than SRB0. The UE inactive AS context may be configurations including the current security key (immediately before transitioning to the RRC inactive mode) of the terminal device 100, the state regarding header compression, the correspondence between the QoS flow and the DRB, Cell Radio Network Temporary Identifier (C-RNTI) in the source (handover source) PCell, and the like. Furthermore, when MR-DC is configured in the terminal device 100, the configurations regarding the SCG may be stored as the UE inactive AS context. Some of the parameters regarding handover such as reconfiguration with sync and some of the parameters configured in the SIB may be excluded from the configurations stored as the UE inactive AS context.

The transition from the RRC inactive mode to the RRC connection mode may be performed by transmitting and receiving messages regarding RRC connection resumption between the terminal device 100 and the base station device 200. FIG. 14B is a diagram illustrating a transition procedure from the RRC inactive mode to the RRC connection mode in a situation where the base station device 200 is a gNB (the master node is a gNB when MR-DC is used) and the core network 300 is 5GC. The terminal device 100 may transition to the RRC connection mode by sending an RRC resume request message (RRCResumeRequest) to the base station device 200, receiving an RRC resume message (RRCResume) from the base station device 200 in response, and performing processing according to the received RRCResume. When the terminal device 100 has stored configurations regarding the SCG as the UE inactive AS context and the SCG is configured to be held when RRC is resumed, the base station device 200 may cause RRCResume to include the SCG configurations, and the configurations may include reconfiguration with sync of the SCG. Also, RRCResumeRequest may be transmitted using the CCCH logical channel. Furthermore, RRCResume may also be transmitted using the DCCH logical channel.

### SCG Failure Information

When MR-DC is configured and the terminal device 100 detects an SCG failure, it may send a message regarding SCG failure information (SCGFailureInformation) to the master node via the MCG. For example, an SCG failure may be detected when the SCG side loses physical layer synchronization, when random access fails on the SCG side, when the number of RLC retransmissions on the SCG side exceeds a threshold, when reconfiguration with sync of the SCG fails, when processing cannot be performed in accordance with the SCG configuration, or when integrity verification of SRB3 fails. When sending a message regarding SCG failure information, the terminal device 100 may perform processing including suspending SCG transmission for all radio bearers, that is, suspending transmission for all radio bearers associated with the SCG. When (NG) EN-DC is used, SCGFailureInformationNR may be transmitted instead of SCGFailureInformation. SCGFailureInformation and SCGFailureInformationNR may be transmitted using the DCCH logical channel.

Upon receiving a message regarding SCG failure information from the terminal device 100, the base station device 200 may transmit a message regarding reconfiguration of RRC connection to the terminal device 100 in order to reconfigure the SCG.

### SCG Inactive

In (NG) EN-DC or NR-DC, the SCG configured for the terminal device 100 may be deactivated (SCG deactivation) to limit communication between the secondary node and the terminal device 100. Hereinafter, a situation where the SCG is in an inactive state may be referred to as in SCG deactivation. A situation where the SCG is in an active state may be referred to as in SCG (re) activation. Turning the SCG into an inactive state may be referred to as SCG deactivation. Turning the SCG in an inactive state into an active state may be referred to as SCG (re) activation.

Also, hereinafter, “reactivation” and “reactivate” include “activation” and “activate”, respectively.

It is assumed that the terminal device 100 in SCG deactivation satisfies a condition including some or all of the following conditions.
When a message regarding reconfiguration of RRC connection of the SCG (for example, RRC reconfiguration message, RRCReconfiguration) is received from the base station device 200, processing in accordance with this message is performed.
Uplink transmission to the SCG side is not performed.
Uplink data for the SCG side may be processed.
PDCCH monitoring (reception) is not performed in the PSCell.
PUSCH is not transmitted to the SCG side.

When the message regarding reconfiguration of RRC connection received from the base station device 200 includes a parameter instructing SCG deactivation and also a parameter regarding reconfiguration with sync of the SCG, the terminal device 100 does not perform random access processing at least in the SCG.

Note that the terminal device 100 in SCG deactivation may perform RRC connection mode communication with the base station device 200 using the MCG.

### First Embodiment

A first embodiment is now described. In communication between the terminal device 100 and the secondary node (base station device 200), the communication system 10 appropriately controls the switching from in SCG deactivation to in SCG (re) activation, or from in SCG (re) activation to in SCG deactivation. Appropriate control may include controlling to avoid unnecessary switching or postponing the switching timing to a needed timing to save power.

### Transition Processing to SCG Deactivation

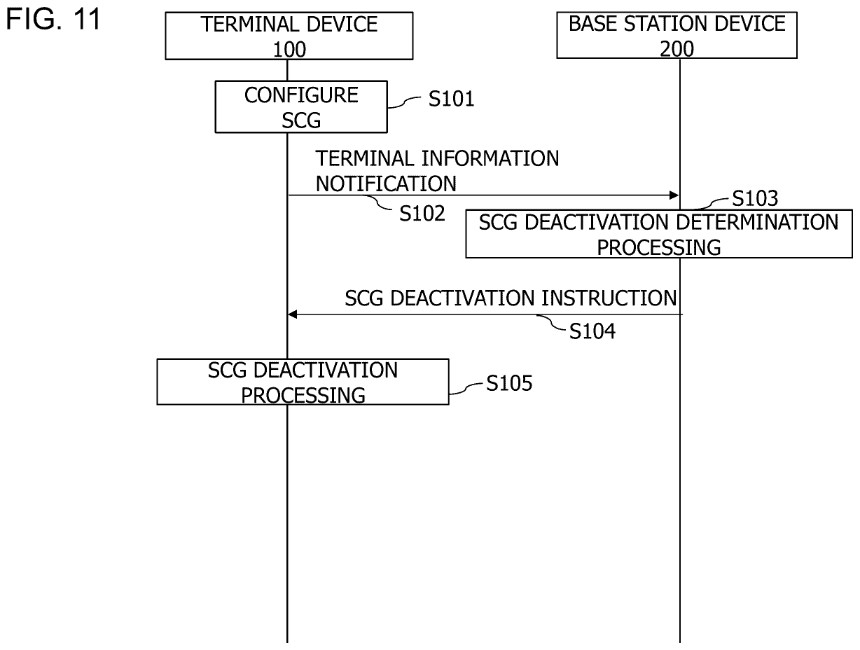

FIG. 11 is a diagram illustrating an example of a sequence in which the state of the SCG changes to inactive state. The base station device 200 may be the master node in MR-DC, for example. The MR-DC in FIG. 11 may be (NG) EN-DC or NR-DC, for example. The sequence of FIG. 11 involves one base station device 200, but a configuration with a plurality of devices of a master node and a secondary node may also be used. Furthermore, in the sequence of FIG. 11, messages transmitted to and received from the base station device 200 may be transmitted to and received from either the master node or the secondary node. When the master node performs the processing performed by the base station device 200 in FIG. 11, it is assumed that a message transmitted from the terminal device 100 to the secondary node is transmitted to the master node via inter-base station communication. The processing to be performed by the base station device 200 may be performed by either the master node or the secondary node. To satisfy the above-mentioned conditions, the terminal device 100 in SCG deactivation does not transmit a message to the secondary node, and does not perform reception from the secondary node through PDCCH.

In the sequence of FIG. 11, the terminal device 100 configures the SCG (S101) and is in SCG (re) activation. SCG configuration is performed when the terminal device 100 receives from the base station device 200 an RRC reconfiguration message including SCG configuration parameters. The SGC configuration parameters may include NR SGC configuration parameters, for example.

The terminal device 100 transmits a terminal information notification to the base station device 200 (S102). The terminal information notification may be an RRC message or a parameter included in an RRC message, for example. Also, the terminal information notification may be UE assistance information of an RRC message, or may be a message with another name.

For example, the terminal information notification may include information indicating whether the terminal device 100 needs to save power. The terminal device 100 determines whether power saving is needed on the basis of the remaining battery level.

Also, the terminal information notification may include information indicating whether SCG deactivation (or SCG release) is needed. For example, the terminal device 100 may determine the necessity on the basis of the amount of communication (data communication amount) with the secondary node.

The terminal information notification may include information indicating whether to, when the SCG reconfiguration with sync parameter is received in SCG deactivation (an instruction to perform SCG reconfiguration with sync is given), perform (want to perform) it immediately.

Furthermore, the terminal information notification may include information indicating to perform (want to perform) SCG reactivation when UL data is generated, without permission of the base station device 200 (without transmitting an SCG reactivation request of processing S110, which will be described below). This allows for the omission of some of the messages between the base station device 200 and the terminal device 100 in SCG reactivation.

Upon receiving a terminal information notification (S102), the base station device 200 performs SCG deactivation determination processing (S103). In addition to when a terminal information notification is received, the base station device 200 may perform SCG deactivation determination processing S103 when an event that involves (or potentially involves) SCG deactivation occurs.

The SCG deactivation determination processing S103 is processing for determining whether to perform SCG deactivation on the terminal device 100. In the SCG deactivation determination processing S103, the base station device 200 performs determination according to the amount of communication between the terminal device 100 and the secondary node. When the amount of communication with the secondary node is low, such as when the amount of communication with the secondary node is less than or equal to a predetermined value in a predetermined period, or when there is no communication with the secondary node for a predetermined time, the base station device 200 determines to perform SCG deactivation.

Furthermore, in the SCG deactivation determination processing S103, the base station device 200 performs determination according to the amount of radio resources that can be allocated to the secondary node. For example, the base station device 200 determines to perform SCG deactivation when the amount of available radio resources of the secondary node is less than or equal to a predetermined value.

When determining to perform SCG deactivation in the SCG deactivation determination processing S103, the base station device 200 transmits an SCG deactivation instruction to the terminal device 100 (S104). The SCG deactivation instruction is a message instructing the terminal device 100 to perform SCG deactivation. The SCG deactivation instruction may be an RRC message or a parameter included in an RRC message. Also, the SCG deactivation instruction may be an SCG deactivation RRC message, for example, or may be a message with another name. Furthermore, the SCG deactivation instruction may be a parameter included in RRCReconfiguration, a parameter included in RRCResume, a parameter included in RRCConnectionReconfiguration, or a parameter included in a message with another name. The SCG deactivation instruction may be a parameter that instructs the terminal device 100 to perform SCG deactivation. The SCG deactivation instruction may also be a parameter indicating that the SCG of the terminal device 100 is in a deactivated state. The SCG deactivation instruction may also be a parameter such as scg-state.

For example, the SCG deactivation instruction may include information indicating whether to, when an instruction to perform SCG reconfiguration with sync is given while the terminal device 100 is in SCG deactivation, immediately perform all or part of the processing of SCG reconfiguration with sync. When the information indicates to immediately perform all, the terminal device 100 immediately performs SCG reconfiguration with sync. When the information indicates not to immediately perform part or all, the terminal device 100 performs, at subsequent SCG reactivation, the part of the processing of SCG reconfiguration with sync that is not performed (suspends reconfiguration with sync), or does not perform part or all of the processing of SCG reconfiguration with sync (discards some or all of the instructions (parameters) for reconfiguration with sync).

Furthermore, the SCG deactivation instruction may include information instructing to immediately perform part or all of the processing of SCG reconfiguration with sync if at least a first condition is not satisfied when the terminal device 100 in SCG deactivation is instructed to perform SCG reconfiguration with sync. In this case, if at least the first condition is not met, the terminal device 100 immediately performs SCG reconfiguration with sync. In this case, if at least the first condition is satisfied, the terminal device 100 performs part of all of the processing of SCG reconfiguration with sync when SCG reactivation is subsequently performed (suspends part or all of the processing of SCG reconfiguration with sync), or does not perform part or all of the processing of SCG reconfiguration with sync (discards part of all of the instruction (parameter) of reconfiguration with sync.

The first condition may be that conditions including some or all of the following Condition 1 to Condition 4 are satisfied.
Condition 1: The SCG reconfiguration with sync is associated with a change of the master node security key (KgNB or KeNB) or a change of the AS security key derived from the master node security key.
Condition 2: The SCG reconfiguration with sync is associated with a change of the secondary node security key (S-KgNB or S-KeNB) or a change of the AS security key derived from the secondary node security key.
Condition 3: The radio bearers associated with the SCG RLC bearer do not include a radio bearer that uses the master key.
Condition 4: The radio bearers associated with the SCG RLC bearer all use the secondary key.

The radio bearer that uses the master key may be a radio bearer for which the parameter indicating whether to use the master key or the secondary key (keyToUse) is set to master (or primary). The radio bearer that uses the secondary key may be a radio bearer for which the parameter indicating whether to use the master key or the secondary key (keyToUse) is set to secondary.

When at least the first condition is satisfied, the communication in MR-DC (particularly the communication using the master node) is not obstructed even if the terminal device 100 does not immediately perform part or all of the processing of SCG reconfiguration with sync. In this manner, the terminal device 100 does not perform unnecessary SCG reactivation, thereby reducing power consumption.

The SCG deactivation instruction may include information instructing to immediately perform SCG reconfiguration with sync when the terminal device 100 in SCG deactivation is instructed to perform SCG reconfiguration with sync. In this case, the terminal device 100 immediately performs SCG reconfiguration with sync regardless of the first condition.

Also, the SCG deactivation instruction may include information instructing to perform SCG reactivation without permission of the base station device 200 when UL data is generated. In this case, the terminal device 100 immediately performs SCG reactivation.

Upon receiving an SCG deactivation instruction (S104), the terminal device 100 performs SCG deactivation processing (S105). The SCG deactivation processing S105 is processing for transition to SCG deactivation. The terminal device 100 may determine that SCG deactivation processing S105 needs to be performed when an SCG deactivation instruction is received, and perform SCG deactivation processing (S105). Also, the terminal device 100 may determine that SCG deactivation processing S105 does not need to be performed when an SCG deactivation instruction is not received, and refrain from performing SCG deactivation processing (S105).

The SCG deactivation processing S105 may include any or all of the following processing steps (1) to (3).
(1) Consider the SCG as being deactivated.
(2) Notify the lower layer that the SCG has been deactivated.
(3) Trigger the PDCP entity of SRB3 to discard SDUs (SDU discard) and/or re-establish the RLC entity of SRB3, if the terminal device 100 is in the RRC connection mode or the RRC inactive mode before receiving an RRC message including an SCG deactivation instruction.

In the above processing (2), the lower layer may be the MAC layer, the RLC layer, or the PDCP layer. The above processing (3) may be performed when SRB3 is configured in the terminal device 100 and SRB3 is not released by the RRC message including the SCG deactivation instruction.

Furthermore, when the terminal device 100 receives an RRC message including an SCG deactivation instruction in SCG deactivation, the terminal device 100 may continue the SCG deactivation state.

Also, when the terminal device 100 in SCG deactivation receives RRCReconfiguration that does not include an SCG deactivation instruction, RRCConnectionReconfiguration that does not include an SCG deactivation instruction, or RRCResume that does not include an SCG deactivation instruction, the terminal device 100 may perform SCG activation processing.

The SCG activation processing may include one or both of the following processing steps (4) and (5).
(4) Consider the SCG as being activated.
(5) Notify the lower layer that the SCG has been activated, if UE100 is in SCG deactivation.

In the above processing (5), the lower layer may be the MAC layer, the RLC layer, or the PDCP layer.

In SCG deactivation processing S105, the terminal device 100 stops some or all of the timers running in relation to the SCG. The terminal device 100 also resets some or all of the counters set in the SCG. The terminal device 100 also resets the MAC of the SCG. The terminal device 100 also performs second processing on all or some of the radio bearers that satisfy at least a second condition. The second condition may be being an SCG bearer, being a split bearer, or being a split bearer with a Primary Path set to the SCG. Also, the second condition may be being some or all of radio bearers configured in the terminal device 100, for example.

The timer running in relation to the SCG to be stopped may include a timer for detecting a radio link failure of the SCG. Also, the timer running in relation to the SCG to be stopped may include a timer for the measurement report of the SCG.

The counters set in the SCG to be reset may include a counter for detecting a radio link failure of the SCG.

Additionally, “performs second processing on all or some of the radio bearers that satisfy at least a second condition” may include a situation where the terminal device 100 determines whether each radio bearer satisfies at least the second condition, and if it is determined that at least the second condition is satisfied, the second processing is performed on this radio bearer.

Furthermore, “performs second processing on all or some of the radio bearers that satisfy at least a second condition” may include a situation where the terminal device 100 determines whether each radio bearer satisfies at least the second condition, and if it is determined that at least the second condition is satisfied and that the second processing needs to be performed on this radio bearer, the second processing is performed on this radio bearer.

In the second condition, “being an SCG bearer” may refer to that one or both of a parameter indicating one or more RLC (moreThanOneRLC) and a parameter indicating Primary Path (primaryPath) are not set in the radio bearer (PDCP of the radio bearer), and the RLC bearer of the radio bearer is in the SCG. Also, “being an SCG bearer” in the second condition may refer to that the RLC bearer of the radio bearer exists only in the SCG. This “RLC bearer of the radio bearer” may be an RLC bearer associated with the radio bearer.

Furthermore, “being a split bearer with a Primary Path set to the SCG” in the second condition may refer to that the Primary Path (or a parameter indicating Primary Path) of the radio bearer (PDCP of the radio bearer) is set to the SCG (or that the SCG is referred to).

The second processing is processing that is performed for all or some of the radio bearers that satisfy at least the second condition. The second processing is all or part of the processing and pre-processing for transition to SCG deactivation. The second processing may include all or part of the following processing. Hereinafter, all or some of the radio bearers that satisfy at least the second condition may be referred to as second radio bearers.
Immediately (before the SCG is deactivated) transmit or discard all data for which transmission has not completed in PDCP of the second radio bearer.
Stop any reordering timer running in PDCP of the second radio bearer, and transmit all stored PDCP SDUs to upper layers in order after decompressing the headers.
Re-establish RLC of the second radio bearer

The second processing may be performed by the following procedure or may include the following procedure.

In the processing of immediately transmitting data for which transmission has not completed in PDCP, for an UM DRB, for example, PDCP SDUs that have been assigned a sequence number but have not been passed to lower layers may be regarded as PDCP SDUs that are newly received from upper layers and transmitted in order. Also, the discard timer does not need to be restarted in this case.

In the processing of immediately transmitting data for which transmission has not completed in PDCP, for an AM DRB or an AM DRB in which the PDCP entity is not suspended, for example, PDCP SDUs for which successful transmission has not been confirmed from lower layers, and/or PDCP SDUs that have been assigned a sequence number but have not been passed to lower layers are transmitted in order.

In the processing of immediately transmitting data for which transmission has not completed in PDCP, for an AM DRB for the Uu interface (interface between the terminal device 100 and the base station device 200) in which the PDCP entity is suspended, for example, PDCP SDUs for which successful transmission has not been confirmed from lower layers, and/or PDCP SDUs that have been assigned a sequence number but have not been passed to lower layers may be regarded as PDCP SDUs that are newly received from upper layers and transmitted in order. Also, the discard timer does not need to be restarted in this case.

The discard timer may be a timer used to discard the corresponding PDCP SDU when it expires.

Examples of actions within the terminal in performing the second processing on all or some of the radio bearers that satisfy at least the second condition are now described.

For example, the RRC of the terminal device 100 issues a second notification to PDCP of all or some of the radio bearers that are SCG bearers or split bearers. PDCP may be replaced by lower layer(s). Upon receiving the second notification, PDCP performs the second processing if the radio bearer is an SCG bearer (with one associated RLC) or a split bearer (with two or more associated RLCs) with a Primary Path set to the SCG side.

For example, the RRC of the terminal device 100 issues a second notification to the second radio bearer. PDCP may be replaced by lower layers(s). Upon receiving the second notification, the PDCP performs the second processing.

Some of the radio bearers that satisfy at least the second condition may be SRBs that satisfy at least the second condition, or DRBs that satisfy at least the second condition. There is no limitation to the above.

The second notification may be a notification that includes information instructing to discard PDCP data. The second notification may also be a notification that includes information instructing to immediately transmit data for which transmission has not completed.

The second notification may also include information indicating that the SCG is deactivated, such as SCG deactivated and CG UL transmission prohibited (suspended).

The second notification may include all or part of the above information. The second notification may also be a plurality of messages including some of the above information.

As a result, even if the PDCP of the SCG is re-established when the terminal device 100, despite having received an instruction for SCG reconfiguration with sync, does not immediately perform it and performs it with delay, uplink transmission resulting from transmission of UL data that has not been successfully transmitted is unlikely to occur. This allows the terminal device 100 to limit unnecessary SCG reactivation and thus limit power consumption.

Furthermore, in SCG deactivation processing S105, the RRC of the terminal device 100 transmits second information to the SDAP that is associated with DRBs of the second radio bearers.

The second information is information indicating that UL transmission is not possible with the DRB, such as that UL transmission is prohibited (or stopped) with the DRB, or that the cell group associated with the DRB is in deactivation.

The second information may also be transmitted to SDAP along with all or part of the following information. Also, the second information may be all or part of the following information.
DRB Identity of the DRB
QoS flow identifier associated with the DRB

Note that “transmits second information to the SDAP that is associated with DRBs of the second radio bearers” may refer to that the terminal device 100 determines whether each DRB satisfies at least the second condition, and if it is determined that the DRB satisfies at least the second condition, the terminal device 100 transmits the second information to the SDAP associated with this DRB.

Also, “transmits second information to the SDAP that is associated with DRBs of the second radio bearers” may refer to that the terminal device 100 determines whether each DRB satisfies at least the second condition, and if it is determined that the DRB satisfies at least the second condition and that the transmission of the second information to the SDAP associated with this DRB is needed, the terminal device 100 transmits the second information to the SDAP associated with this DRB.

The second information transmission processing may be performed if a DRB that satisfies at least the second condition is associated with SDAP (if SDAP entity associated with this DRB configured). The terminal device 100 may determine whether each DRB is associated with SDAP, and if it is determined that the DRB is associated with SDAP, determine whether this DRB satisfies at least the second condition. The terminal device 100 may also determine whether each DRB satisfies at least the second condition, and if it is determined that at least the second condition is satisfied, determine whether this DRB is associated with SDAP.

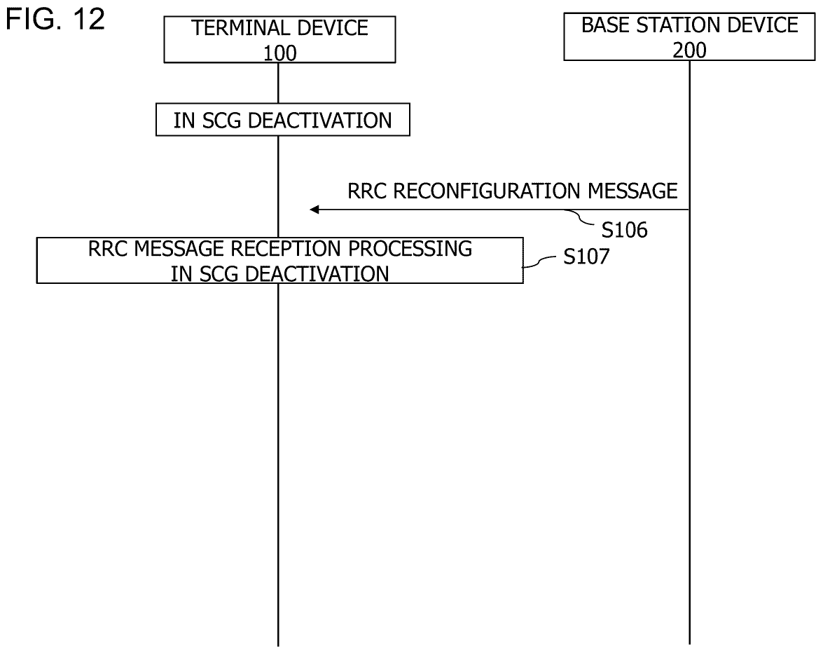

RRC Reconfiguration Message Reception Processing in SCG Deactivation FIG. 12 is a diagram illustrating an example of a sequence in which the terminal device 100 in SCG deactivation receives an RRC reconfiguration message.

The base station device 200 transmits an RRC reconfiguration message (first message) to the terminal device 100 in SCG deactivation (S106). The RRC reconfiguration message is an RRC message that is transmitted from the base station device 200 to the terminal device 100 regarding RRC connection reconfiguration, and may perform establishment, configuration, modification, release, and reconfiguration with sync of radio bearers, cell groups, and measurement information, for example. The RRC reconfiguration message may be RRCReconfiguration of RRC message, or may be a message with another name.

When the base station device 200 determines that a change of the configuration of the terminal device 100 (change of the configuration in RRC connection mode) is needed, it generates an RRC reconfiguration message and transmits it to the terminal device 100.

For example, when an MGC handover is needed, the base station device 200 determines that the configuration of the terminal device 100 needs to be changed.

Also, when a security key needs to be changed, the base station device 200 determines that the configuration of the terminal device 100 needs to be changed. When the PDCP associated with the security key that needs to be changed (PDCP that uses a key that is derived from the security key) needs to be re-established, the base station device 200 determines that the configuration of the terminal device 100 needs to be changed.

Also, when the QoSflow to DRB mapping rule (a rule indicating the relationship (map) between QoS flow and DRB) needs to be changed, for example, the base station device 200 determines that the configuration of the terminal device 100 needs to be changed.

The RRC reconfiguration message may include the following information.
Information instructing to perform SCG reconfiguration with sync
Information instructing to immediately perform SCG reconfiguration with sync, if the message includes information instructing to perform SCG reconfiguration with sync and if at least the first condition is not satisfied.
Information instructing to perform SCG reconfiguration with sync at SCG reactivation, if the message includes information instructing to perform SCG reconfiguration with sync and if at least the first condition is satisfied.
Information instructing to immediately perform SCG reconfiguration with sync, if the message includes information instructing to perform SCG reconfiguration with sync and the SCG is deactivated.
Information instructing to perform SCG reconfiguration with sync at SCG reactivation, if the message includes information instructing to perform SCG reconfiguration with sync.

The first condition is the first condition described for processing S103. That is, the first condition may be that conditions including all or some of Conditions 1 to 4 below are satisfied.
Condition 1: The SCG reconfiguration with sync is associated with a change of the master node security key (KgNB or KeNB) or a change of the AS security key derived from the master node security key.
Condition 2: The SCG reconfiguration with sync is associated with a change of the secondary node security key (S-KgNB or S-KeNB) or a change of the AS security key derived from the secondary node security key.
Condition 3: The radio bearers associated with the SCG RLC bearer do not include a radio bearer that uses the master key.
Condition 4: The radio bearers associated with the SCG RLC bearer all use the secondary key.

The radio bearer that uses the master key may be a radio bearer for which the parameter indicating whether to use the master key or the secondary key (keyToUse) is set to master (or primary). The radio bearer that uses the secondary key may be a radio bearer for which the parameter indicating whether to use the master key or the secondary key (keyToUse) is set to secondary.

When the base station device 200 determines that it does not want the terminal device 100 to immediately perform SCG reconfiguration with sync, the RRC reconfiguration message does not need to include the reconfiguration with sync parameter in the parameters indicating SCG configuration (e.g., the name secondaryCellGroup) (SCG reconfiguration with sync does not have to be requested).

Furthermore, when the terminal device 100 is in SCG deactivation, the base station device 200 may determine that including the SCG reconfiguration with sync parameter in the RRC reconfiguration message to the terminal device 100 is optical (not mandatory).

For example, when the secondary node security key needs to be updated, the base station device 200 does not cause the SCG reconfiguration with sync parameter to be included, if the terminal device 100 is in SCG deactivation and an MN-terminated RLC bearer (associated with the master key) does not exist on the SCG side.

Also, if at least the third condition is satisfied and the terminal device 100 is not in SCG deactivation, the base station device 200 may determine that the inclusion of the SCG reconfiguration with sync parameter in the RRC reconfiguration message to the terminal device 100 is mandatory and thus always cause a SCG reconfiguration with sync parameter to be included. Also, if the terminal device 100 is in SCG deactivation, the base station device 200 may determine that the inclusion of the SCG reconfiguration with sync parameter in the RRC reconfiguration message to the terminal device 100 is optional (not mandatory) even when at least the third condition is satisfied, and thus does not cause the SCG reconfiguration with sync parameter to be included.

For example, the third condition may be that the AS security key derived from the secondary node security key (S-KgNB or S-KeNB) in NR-DC is changed, one or more radio bearers using the secondary key are configured for the terminal device 100, and these radio bearers are not released even when the processing associated with receiving an RRC reconfiguration request is performed.

In another example, the third condition may be that the base station device 200 performs MN handover in (NG) EN-DC.

In another example, the third condition may be that the base station device 200 performs SCG reactivation.

Also, if the RRC reconfiguration message to the terminal device 100 is to include a change of the AS security key derived from the master node security key (KgNB or KeNB) but not the SCG reconfiguration with sync parameter and if the terminal device 100 is not in SCG deactivation, the base station device 200 may determine to release all existing SCG RLC bearers associated with the radio bearers that use the master key and determine to release all existing SCG RLC bearers associated with the radio bearers that use the master key.

Also, if the RRC reconfiguration message to the terminal device 100 is to include a change of the AS security key derived from the master node security key (KgNB or KeNB) but not the SCG reconfiguration with sync parameter and if the terminal device 100 is in SCG deactivation, the base station device 200 may determine that it is unnecessary to release all existing SCG RLC bearers associated with the radio bearers that use the master key and determine that it is unnecessary to release all existing SCG RLC bearers associated with the radio bearers that use the master key.

Furthermore, the base station device 200 may cause the RRC reconfiguration message to include a parameter instructing to perform SCG reconfiguration with sync and a parameter instructing to perform SCG deactivation.

Note that including the SCG reconfiguration with sync parameter may refer to including the reconfiguration with sync parameter in the SCG configuration parameters. The radio bearer that uses the master key may be a radio bearer for which the parameter indicating whether to use the master key or the secondary key (keyToUse) is set to master (or primary). The radio bearer that uses the secondary key may be a radio bearer for which the parameter indicating whether to use the master key or the secondary key (keyToUse) is set to secondary.

Upon receiving an RRC reconfiguration message (S106), the terminal device 100 performs RRC reconfiguration message reception processing in SCG deactivation (S107). In the SCG deactivation RRC reconfiguration message reception processing in SCG deactivation S107, the terminal device 100 performs processing in accordance with the information (parameters) included in the RRC reconfiguration message.

The RRC reconfiguration message may include the following parameters.
Reconfiguration with sync parameter (instructing to perform reconfiguration with sync)
Parameter instructing PDCP re-establishment (instructing to perform PDCP re-establishment)
Parameter indicating QoS flow to DRB mapping rule configuration (instructing to perform reconfiguration of QoSflow to DRB mapping rule) The processing performed when each parameter is included is now described.
   1. Reconfiguration with Sync Parameter is Included

If the received RRC reconfiguration message includes the reconfiguration with sync parameter, a predetermined condition is satisfied, and the SCG side radio bearers are suspended, the terminal device 100 resumes the UL communication of the suspended SCG side radio bearers. The predetermined condition may be that the terminal device 100 is not in SCG deactivation. Note that “a predetermined condition is satisfied” may be paraphrased as “it is determined whether a predetermined condition is satisfied, and if the predetermined condition is satisfied”. The predetermined condition may be any one of Conditions 1 to 3 below.
(Condition 1) Conditions including all or some of the following conditions are satisfied.
The CellGroupConfig procedure is initiated by the MCG configuration parameter, and the terminal device 100 is not in SCG deactivation.
The process is initiated by the SCG configuration parameters.
(Condition 2) Conditions including all or some of the following conditions are satisfied.
The CellGroupConfig procedure is initiated by the MCG configuration parameter, and the terminal device 100 is not in SCG deactivation.
The procedure is initiated by the SCG configuration parameter, the terminal device 100 is in SCG deactivation, and a parameter indicating to immediately perform SCG reconfiguration with sync is included (or a parameter indicating that SCG reconfiguration with sync is not performed immediately is not included).
The procedure is initiated by the SCG configuration parameter, and the terminal device 100 is not in SCG deactivation.
(Condition 3) Conditions including all or some of the following conditions are satisfied.
The terminal device 100 is not in SCG deactivation.
The terminal device 100 is in SCG deactivation, and a parameter indicating to immediately perform SCG reconfiguration with sync is included (or a parameter indicating that SCG reconfiguration with sync is not performed immediately is not included).

In SCG deactivation, the terminal device 100 may determine that the SCG side radio bearers are not in a suspended state but in a different state (for example, the SCG is in a deactivated state, or uplink transmission is prohibited). When the reconfiguration with sync parameter is included, the terminal device 100 may reinitiate UL communication of the suspended SCG side radio bearers regardless of whether the terminal device 100 is in SCG deactivation.

Furthermore, when the received RRC reconfiguration message includes the SCG reconfiguration with sync parameter, the terminal device 100 may perform the following processing.
The terminal device 100 may immediately perform processing of SCG reconfiguration with sync.

Also, the terminal device 100 does not immediately perform part or all of the processing of SCG reconfiguration with sync, and the processing that is not immediately performed is performed at SCG reactivation. Examples of the processing that is immediately performed include MAC reset and applying the identifier of the new terminal device 100 as the C-RNTI of the cell group on the SCG side. Examples of the processing performed at SCG reactivation may include random access processing (which may include processing of configuring lower layers in accordance with the received parameter indicating common SpCell configuration (SpCellConfigCommon), and starting a timer to detect failure of reconfiguration with sync on the SCG side.

The terminal device 100 may determine whether to immediately perform processing of SCG reconfiguration with sync from the SCG deactivation instruction in processing S104 or the parameter included in the RRC reconfiguration message in processing S106 (parameter indicating whether to immediately perform SCG reconfiguration with sync). For example, the terminal device 100 may immediately perform the processing if at least the first condition is not met, or may perform the processing at SCG reactivation if at least the first condition is met. Furthermore, after the terminal device 100 performs the above-described processing, it may return to in SCG deactivation.

The first condition is the first condition described for processing S103. That is, the first condition may be that conditions including all or some of Conditions 1 to 4 below are satisfied.
Condition 1: The SCG reconfiguration with sync is associated with a change of the master node security key (KgNB or KeNB) or a change of the AS security key derived from the master node security key.
Condition 2: The SCG reconfiguration with sync is associated with a change of the secondary node security key (S-KgNB or S-KeNB) or a change of the AS security key derived from the secondary node security key.
Condition 3: The radio bearers associated with the SCG RLC bearer do not include a radio bearer that uses the master key.
Condition 4: The radio bearers associated with the SCG RLC bearer all use the secondary key.

The radio bearer that uses the master key may be a radio bearer for which the parameter indicating whether to use the master key or the secondary key (keyToUse) is set to master (or primary). The radio bearer that uses the secondary key may be a radio bearer for which the parameter indicating whether to use the master key or the secondary key (keyToUse) is set to secondary.

### 2. Parameter Instructing PDCP Re-Establishment is Included

If the received RRC reconfiguration message includes a parameter instructing PDCP re-establishment, the terminal device 100 may immediately perform PDCP re-establishment, for example. In this case, if there is data for which transmission has not completed in PDCP of all or some of the radio bearers that satisfy at least the second condition, the terminal device 100 may transmit the data after SCG is reactivated.

Furthermore, the terminal device 100 may perform PDCP re-establishment of all or some of the radio bearers that satisfy at least the second condition after the SCG is reactivated. In this case, when the PDCP for which PDCP re-establishment is performed after SCG reactivation receives a PDCP SDU from upper layers, the PDCP does not perform processing associated with the PDCP SDU.

The second condition may be the second condition in processing 105, that is, being an SCG bearer or being a split bearer with a Primary Path set to the SCG.

In the processing of transmitting data for which transmission has not completed in PDCP, for an UM DRB, for example, the terminal device 100 regards the PDCP SDUs that have been assigned a sequence number but have not been passed to lower layers as the PDCP SDUs that are newly received from upper layers, and transmit them in order. In this case, the discard timer does not need to be restarted.

In the processing of transmitting data for which transmission has not completed in PDCP, for an AM DRB or an AM DRB in which the PDCP entity is not suspended, for example, the terminal device 100 transmits the PDCP SDUs for which successful transmission has not been confirmed from lower layers, and the PDCP SDUs that have been assigned a sequence number but have not been passed to lower layers in order.

Also, in the processing of transmitting data for which transmission has not completed in PDCP, for an AM DRB for the Uu interface (interface between the terminal device 100 and the base station device 200) in which the PDCP entity is suspended, for example, the terminal device 100 regards the PDCP SDUs for which successful transmission has not been confirmed from lower layers, and the PDCP SDUs that have been assigned a sequence number but have not been passed to lower layers as the PDCP SDUs that are newly received from upper layers and transmit them in order. In this case, the discard timer does not need to be restarted.

The discard timer may be a timer used to discard the corresponding PDCP SDU when it expires.

The base station device 200 may cause the RRC reconfiguration message in processing S106 to include a parameter indicating to immediately perform re-establishment processing for the PDCP of all or some radio bearers that satisfy at least the second condition (or perform it after SCG is reactivated). The terminal device 100 may determine from this parameter whether to perform the re-establishment processing for the PDCP of all or some of the radio bearers that satisfy at least the second condition immediately or after the SCG is reactivated.

### 3. Parameter Indicating QoS Flow to DRB Mapping Rule Configuration is Included

If the received RRC reconfiguration message includes a parameter indicating QoS flow to DRB mapping rule configuration (mappedQoS-FlowToAdd), the terminal device 100 performs the following processing. The QoS flow to DRB mapping rule indicates the correspondence between a QoS flow and a DRB.

For example, the terminal device 100 may perform end marker processing if a predetermined condition is satisfied. The end marker processing is processing of constructing an end marker control PDU, mapping it to the DRB before change, and transmitting it to lower layers. Note that “a predetermined condition is satisfied” may be paraphrased as “it is determined whether a predetermined condition is satisfied, and the predetermined condition is satisfied”.

For example, assume that mappedQoS-FlowToAdd included in the received RRC reconfiguration message is a parameter for the first QoS flow.

The terminal device 100 performs the end marker processing if conditions including all or some of Conditions 1 to 3 below are satisfied, and if the DRB of the QoS flow to DRB mapping rule stored for the first QoS flow (that is, the DRB that is already stored and associated with the first QoS flow) is a DRB that does not correspond to second information received from the RRC of the terminal device 100 in processing S105. Also, even when conditions including all or some of Conditions 1 to 3 below are satisfied, the terminal device 100 does not perform the end marker processing if the DRB of the QoS flow to DRB mapping rule stored for the first QoS flow is a DRB that corresponds to the second information received from the RRC of the terminal device 100 in processing S105.
(Condition 1) In processing S105, the SDAP associated with the data radio bearer that satisfies at least the second condition has been notified of the second information.
(Condition 2) The QoS flow to DRB mapping rule stored for the first QoS flow differs from the QoS flow to DRB mapping rule that is configured (by mappedQoS-FlowToAdd included in the received RRC reconfiguration message). In other words, the DRB that is associated with the first QoS flow according to the QoS flow to DRB mapping rule that is newly received has been modified from the DRB that is associated according to the QoS flow to DRB mapping rule that is stored (has been already received).
(Condition 3) An uplink SDAP header is configured in the DRB of the QoS flow to DRB mapping rule that is stored.

Furthermore, the terminal device 100 may perform all or part of the processing if the SDAP entity is already established, the QoS flow to DRB mapping rule for the first Qos flow does not exist (is not stored), and a default DRB is configured.
(Processing 1) If the default DRB is a DRB that does not correspond to the second information received from the RRC of the terminal device 100 in processing S105, an end marker control PDU is constructed, mapped to the default DRB, and transmitted to lower layers.
(Processing 2) If the default DRB is a DRB corresponding to the second information received from the RRC of the terminal device 100 in processing S105, all or part of construction of an end marker control PDU, mapping of the constructed end marker control PDU to the default DRB, and transmission to lower layers is not performed.

The QoS flow to DRB mapping rule may be a QoS flow to DRB mapping rule for uplink (UL QoS flow to DRB mapping rule).

Also, in processing S105, if the second notification to the PDCP from the RRC of the terminal device 100 has been issued (if the PDCP has been identified as the PDCP of a radio bearer that satisfies at least the second condition), the terminal device 100 creates an end marker control PDU (SDAP Control PDU) and transmit it to PDCP. Upon receiving the SDAP Control PDU, the PDCP of the terminal device 100 discards the received SDAP Control PDU. Alternatively, if it is a split bearer with a Primary Path set to the SCG, the PDCP of the terminal device 100 may discard the SDAP Control PDU.

The base station device 200 may be implemented such that the end marker control PDU is not transmitted to the SCG when the terminal device 100 is in SCG deactivation. For example, the base station device 200 does not cause the RRC reconfiguration message that is to be transmitted to the terminal device 100 to include mappedQoS-FlowToAdd when the terminal device 100 is in SCG deactivation. For example, if the base station device 200 causes the RRC reconfiguration message that is to be transmitted to the terminal device 100 to include mappedQoS-FlowToAdd when the terminal device 100 is in SCG deactivation, the base station device 200 performs configuration such that the terminal device 100 does not transmit the end marker control PDU to the SCG side.

Also, if the terminal device 100 determines that the processing in accordance with the RRC reconfiguration message received from the base station device 200 is not possible, the terminal device 100 may initiate, with respect to the base station device 200, an RRC connection re-establishment procedure or a procedure regarding SCG radio link failure. For example, the terminal device 100 may determine that the processing in accordance with the received RRC reconfiguration message is not possible, if the RRC reconfiguration message received from the base station device 200 does not include the reconfiguration with sync parameter even though the message meets the condition with which the inclusion of the reconfiguration with sync parameter is mandatory. Also, the terminal device 100 may determine the processing in accordance with the received RRC reconfiguration message is not possible if the RRC reconfiguration message received from the base station device 200 causes end marker transmission to the SCG although the terminal device 100 is in SCG deactivation.

### UL Data Arrival in SCG Deactivation

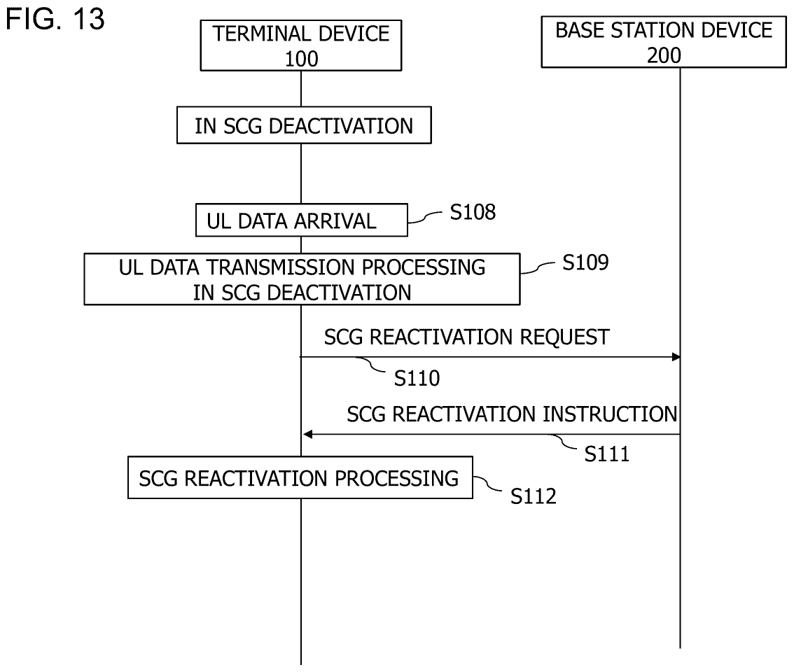

FIG. 13 is a diagram illustrating an example of a sequence of UL data arrival in SCG deactivation. UL data arrives at the terminal device 100 in SCG deactivation (S108). The arrival of UL data indicates that data to be transmitted to the base station device 200 is generated, and may be the arrival (transmission) of a PDCP SDU to the PDCP, or the arrival (transmission) of MAC SDU to the MAC on the SCG side.

When UL data arrives (S108), the terminal device 100 performs UL data transmission processing in SCG deactivation (S109). The UL data transmission processing in SCG deactivation S109 is processing of determining whether to transmit the UL data to the master node or the secondary node and whether to transmit it immediately, for example, and transmitting the UL data at appropriate timing. The UL data transmission processing in SCG deactivation S109 is described below separately for a situation where a PDCP SDU arrives at PDCP, and for a situation where an MAC SDU arrives at MAC on the SCG side.

### 1. PDCP SDU Arrives at PDCP

For example, in processing S105, if the second notification to the PDCP from the RRC of the terminal device 100 has been issued (if the PDCP has been identified as the PDCP of a radio bearer that satisfies at least the second notification), the PDCP of the terminal device 100 that detects arrival of a PDCP SDU notifies the RRC of the terminal device 100 of the generation of UL data. At this time, if it is a split bearer with a Primary Path set to the SCG, the terminal device 100 may notify the RRC of the terminal device 100 when a PDCP SDU is received from upper layers. In contrast, if it is a split bearer with a Primary Path set to the MCG, the terminal device 100 may notify the RRC of the terminal device 100 when the transmission data amount exceeds or is likely to exceed the threshold.

Upon receiving the notification of the generation of UL data from the PDCP of the terminal device 100, the RRC of the terminal device 100 transmits an SCG reactivation request to the base station device 200 (S110). The SCG reactivation request may be a message requesting to perform SCG reactivation, or a message including a parameter requesting to perform SCG reactivation.

The SCG reactivation request may also be an RRC message, for example. Furthermore, the SCG reactivation request may be SCG reactivation request of an RRC message, or may be a message with another name.

### 2. MAC SDU Arrives at MAC on SCG Side

The processing of the RRC of the terminal device 100 is similar to that in the situation where a PDCP SDU arrives at the PDCP described above. Upon detecting the arrival of an MAC SDU, the MAC of the terminal device 100 notifies the RRC of the terminal device 100 of the generation of UL data. Also, the MAC of the terminal device 100 may perform SCG reactivation and prepare for transmitting the UL data (for example, perform a random access procedure with respect to the secondary node). The terminal device 100 may first perform the SCG reconfiguration with sync if there is SCG reconfiguration with sync that is not immediately performed in processing S107, for example. Also, the MAC of the terminal device 100 may perform all processing relating to SCG reactivation after receiving an SCG reactivation instruction from the base station device 200.

Furthermore, the MAC of the terminal device 100 may perform SCG reactivation and start transmitting the UL data without notifying the RRC of the terminal device 100 of the generation of UL data. Before starting the transmission of the UL data, the terminal device 100 may perform SCG reconfiguration with sync if there is SCG reconfiguration with sync that was not immediately performed in processing S107, for example

For example, if the SCG deactivation instruction received in processing S104 includes an instruction regarding the processing for UL data generation in SCG deactivation (such as whether SCG reactivation can be performed without transmission of an SCG reactivation request), the terminal device 100 may follow the instruction.

The base station device 200 determines whether SCG reactivation of the terminal device 100 is needed. The base station device 200 determines that SCG reactivation of the terminal device 100 is needed if conditions including some or all of the following Conditions 1 to 3 are met.
(Condition 1) An SCG reactivation request is received from the terminal device 100.
(Condition 2) DL data to be transmitted to the terminal device 100 via the SCG is generated.
(Condition 3) The remaining radio resources of the secondary node are sufficient (equal to or more than the threshold).

The base station device 200 may determine whether SCG reactivation of the terminal device 100 is needed at any time as long as the terminal device 100 is in SCG deactivation.

When determining that SCG reactivation is needed, the base station device 200 transmits to the terminal device 100 an SCG reactivation instruction to instruct (permit) to perform SCG reactivation (S111). The SCG reactivation instruction may be an RRC message. Also, the SCG reactivation instruction may be RRCReconfiguration of an RRC message or a message with another name. Furthermore, the SCG reactivation instruction may be RRCReconfiguration that does not include an SCG deactivation instruction.

Upon receiving the SCG reactivation instruction (S111), the terminal device 100 performs SCG reactivation processing (S112). The SCG reactivation processing S112 is processing in which the terminal device 100 reactivates the SCG.

The RRC of the terminal device 100 may transmit a third notification to the PDCP to which the second notification is transmitted in processing S105. The third notification may be a notification indicating SCG reactivation or a notification indicating SCG deactivation cancellation, and may be “SCG has been reactivated”, “SCG uplink transmission is permitted (resumed)”, or the like. Upon receiving the third notification, the PDCP of the terminal device 100 resumes UL transmission of the SCG.

RRC Message Processing while SCG Side Radio Bearers are Suspended

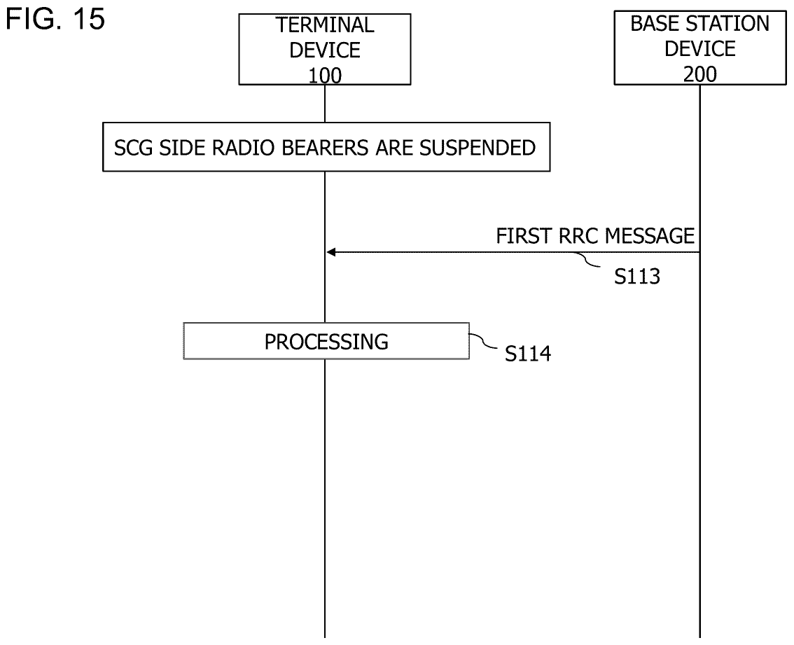

FIG. 15 is a diagram illustrating an example of a sequence for receiving a first RRC message when the radio bearers at least on the SCG side of the terminal device 100 are in a suspended state (the radio bearers are suspended). The radio bearers at least on the SCG side of the terminal device 100 being suspended may be a situation where the terminal device 100 is in an RRC inactive mode. Also, the radio bearers at least on the SCG side of the terminal device 100 being suspended may be a state in which the terminal device 100 detects an SCG failure and SCG transmission of the radio bearers is suspended. Furthermore, the radio bearers being suspended may be a state that includes some or all of a state in which no transmission is performed on the radio bearers, no reception is performed on the radio bearers, and no data processing is performed in some or all of the entities configured in the radio bearers. Furthermore, the SCG transmission of the radio bearers being suspended may be a state including a state in which no transmission is performed on the radio bearers associated with the SCG, for example.

The terminal device 100 with which the radio bearers at least on the SCG side are suspended may be in SCG deactivation. The terminal device 100 with which the radio bearers at least on the SCG side are suspended may also be in SCG activation.

The first RRC message may be an RRCResume message when the terminal device 100 is in an RRC inactive mode. In this case, the terminal device 100 may transmit RRCResumeRequest to the base station device 200 before receiving the first RRC message from the base station device 200. The first RRC message may be RRCReconfiguration when the terminal device 100 is in an RRC connection mode. An RRCResume message may include RRCReconfiguration, and this RRCReconfiguration may include SCG configurations.

The base station device 200 transmits a first RRC message to the terminal device 100 with which the radio bearers at least on the SCG side are suspended (S113). When the base station device 200 determines that the terminal device resumes transmission of the suspended radio bearers on the SCG side, it transmits to the terminal device 100 a first RRC message that includes the first parameter and does not include the second parameter. When the base station device 200 determines that the terminal device 100 does not resume transmission of the suspended radio bearers on the SCG side, it transmits to the terminal device 100 a first RRC message that includes the first parameter and the second parameter.

The above-mentioned “resumes transmission of the suspended radio bearers on the SCG side” may be rephrased as “resumes transmission of the suspended radio bearers on the SCG side and performs random access to the SCG”.

The above-mentioned “does not resume transmission of the suspended radio bearers on the SCG side” may be rephrased as “does not resume transmission of the suspended radio bearers on the SCG side, and does not perform random access to the SCG”.

The terminal device 100 with which the radio bearers at least on the SCG side are suspended performs processing according to the first RRC message received from the base station device 200 (S114). When the first RRC message received from the base station device 200 includes the first parameter but not the second parameter, the terminal device 100 with which the radio bearers at least on the SCG side are suspended determines to resume transmission of the suspended radio bearers on the SCG side, and resumes transmission of the suspended radio bearers on the SCG side. When the first RRC message received from the base station device 200 includes the first parameter and the second parameter, the terminal device 100 with which the radio bearers at least on the SCG side are suspended determines not to resume transmission of the suspended radio bearers on the SCG side, and does not resume transmission of the suspended radio bearers on the SCG side.

The above-mentioned “when the first RRC message received from the base station device 200 includes the first parameter but not the second parameter” may be rephrased as “when the first RRC message received from the base station device 200 includes the first parameter and the SCG is not deactivated” or “when the first RRC message received from the base station device 200 includes the first parameter and the SCG is activated”.

Furthermore, the above-mentioned “when the first RRC message received from the base station device 200 includes the first parameter and the second parameter” may be rephrased as “when the first RRC message received from the base station device 200 includes the first parameter and the SCG is deactivated” or “when the first RRC message received from the base station device 200 includes the first parameter and the SCG is not activated”.

The above-mentioned “resumes transmission of the suspended radio bearers on the SCG side” may be rephrased as “resumes transmission of the suspended radio bearers on the SCG side and performs random access to the SCG”.

The above-mentioned “does not resume transmission of the suspended radio bearers on the SCG side” may be rephrased as “does not resume transmission of the suspended radio bearers on the SCG side, and does not perform random access to the SCG”.

The above-mentioned first parameter may be a reconfiguration with sync parameter. Also, the above-mentioned first parameter may be a reconfiguration with sync parameter of the SCG.

The above-mentioned second parameter may be an SCG deactivation instruction. The SCG deactivation instruction may be a parameter that instructs the terminal device 100 to perform SCG deactivation. The SCG deactivation instruction may also be a parameter indicating that the SCG of the terminal device 100 is in a deactivated state. The SCG deactivation instruction may also be a parameter called scg-state.

The above-mentioned processing that “resumes transmission of the suspended radio bearers on the SCG side” or the processing that “does not resume transmission of the suspended radio bearers on the SCG side” may be processing performed after reconfiguration with sync processing.

Also, the above-mentioned processing that “resumes transmission of the suspended radio bearers on the SCG side” or the processing that “does not resume transmission of the suspended radio bearers on the SCG side” may be processing performed after the processing of resuming the suspended radio bearers or processing performed simultaneously with the processing of resuming the suspended radio bearers. The processing of resuming the suspended radio bearers may be processing of resuming data processing in each entity configured in the radio bearers, for example. The processing of resuming the suspended radio bearers does not have to be performed on a portion of the suspended radio bearers. This portion of the suspended radio bearers may be SRBs for the source cell group, for example.

The above-mentioned processing that “does not resume transmission of the suspended radio bearers on the SCG side” may be processing performed after the SCG deactivation processing.

The radio bearers on the SCG side may refer to the radio bearers associated with the SCG.

The same processing as that for the radio bearers on the SCG side described above may be performed on the Backhaul (BH) RLC channel for the Integrated Access and Backhaul-Mobile Termination (IAB-MT) on the SCG side. In other words, when it is determined to “resume transmission of the suspended radio bearers on the SCG side”, SCG transmission over the BH RLC channel for the suspended IAB-MT may be resumed. When it is determined “not to resume transmission of the suspended radio bearers on the SCG side”, SCG transmission over the BH RLC channel for the suspended IAB-MT does not have to be resumed.

This prevents data transmission in SCG deactivation, thereby reducing power consumption of the terminal device.

The terminal device 100 with which the radio bearers at least on the SCG side are suspended may perform the following processing instead of the processing of determining whether to resume transmission of the suspended radio bearers on the SCG side.
When the first RRC message includes reconfiguration with sync, resume transmission of the suspended radio bearers on the SCG side regardless of whether the first RRC message includes an SCG deactivation instruction.
Perform SCG deactivation processing and/or reconfiguration with sync processing after the processing of resuming the suspended radio bearers on the SCG side described above.

### Second Embodiment

Assume that the terminal device 100 is in SCG deactivation, Reflective QoS flow to DRB mapping Indication (RDI) is set to “1” in the SDAP entity of the terminal device 100, a downlink SDAP data PDU is received, and the received downlink SDAP data PDU includes a QoS flow identifier (QFI) for the second QoS flow. The downlink SDAP data PDU may be received via a DRB with an RLC bearer associated with the MCG.

The terminal device 100 performs the end marker processing if conditions including all or some of Conditions 1 to 3 below are satisfied, and the DRB of the QoS flow to DRB mapping rule stored for the second QoS flow (that is, the DRB that is already stored and associated with the first QoS flow) is a DRB that does not correspond to second information received from the RRC of the terminal device 100 in the first embodiment. Also, even when conditions including all or some of Conditions 1 to 3 below are satisfied, the terminal device 100 does not perform the end marker processing if the DRB of the QoS flow to DRB mapping rule stored for the second QoS flow is a DRB that corresponds to the second information received from the RRC of the terminal device 100. The end marker processing is processing of constructing an end marker control PDU, mapping it to the DRB before change, and transmitting it to lower layers.
(Condition 1) In processing S105 of the first embodiment, the SDAP associated with the DRB that satisfies at least the second condition has been notified of the second information.
(Condition 2) The QoS flow to DRB mapping rule stored for the first QoS flow differs from the QoS flow to DRB mapping rule of the received downlink SDAP data PDU. In other words, the DRB that is associated with the second QoS flow according to the Qos flow to DRB mapping rule that is newly received in the downlink SDAP data PDU is changed from the DRB that is associated according to the stored QoS flow to DRB mapping rule.
(Condition 3) An uplink SDAP header is configured in the DRB of the stored QoS flow to DRB mapping rule.

Furthermore, the terminal device 100 may perform all or part of the processing if the QoS flow to DRB mapping rule for the second QoS flow does not exist (is not stored), and the default DRB is configured.
(Processing 1) When the default DRB is a DRB that does not correspond to the second information received from the RRC of the terminal device 100 in the first embodiment, an end marker control PDU is constructed, mapped to the default DRB, and transmitted to lower layers.
(Processing 2) When the default DRB is a DRB corresponding to the second information received from the RRC of the terminal device 100 in the first embodiment, all or part of construction of an end marker control PDU, mapping of the constructed end marker control PDU to the default DRB, and transmission to lower layers is not performed. The QoS flow to DRB mapping rule may be a QoS flow to DRB mapping rule for uplink (UL QoS flow to DRB mapping rule).

When the terminal device 100 receives a RRC reconfiguration message and the RRC reconfiguration message message includes the SCG reconfiguration with sync parameter, the terminal device 100 determines whether to immediately perform part of all of processing of SCG reconfiguration with sync. When the terminal device 100 determines that part or all of the processing of SCG reconfiguration with sync is not to be performed immediately, it performs, at SCG reactivation, the processing of SCG reconfiguration with sync that is not performed. The terminal device 100 may determine not to perform immediately when some or all of the following conditions are met, for example.
The SCG is deactivated.
The SCG reconfiguration with sync is associated with a change of the master node security key (KgNB or KeNB) or a change of the AS security key derived from the master node security key.
The SCG reconfiguration with sync is associated with a change of the secondary node security key (S-KgNB or S-KeNB) or a change of the AS security key derived from the secondary node security key.
The radio bearers associated with the SCG RLC bearer do not include a radio bearer that uses the master key.
The radio bearers associated with the SCG RLC bearer all use the secondary key.
The base station device is instructed to perform at SCG reactivation.

This limits the implementation of SCG reactivation caused when SCG reconfiguration with sync is performed, thereby limiting the power consumption of the terminal device 100.

Furthermore, if the base station device 200 determines that it does not want the SCG of the terminal device 100 to immediately perform SCG reconfiguration with sync, the base station device 200 does not cause the reconfiguration with sync parameter to be included in the SCG configuration parameters in the RRC reconfiguration message. The base station device 200 determines that it does not want immediate execution when a condition including some or all of the following conditions is met.
The SCG is deactivated.
The SCG reconfiguration with sync is associated with a change of the master node security key (KgNB or KeNB) or a change of the AS security key derived from the master node security key.
The SCG reconfiguration with sync is associated with a change of the secondary node security key (S-KgNB or S-KeNB) or a change of the AS security key derived from the secondary node security key.
The radio bearers associated with the SCG RLC bearer do not include a radio bearer that uses the master key.
The radio bearers associated with the SCG RLC bearer all use the secondary key.

The radio bearer that uses the master key may be a radio bearer for which the parameter indicating whether to use the master key or the secondary key (keyToUse) is set to master (or primary). The radio bearer that uses the secondary key may be a radio bearer for which the parameter indicating whether to use the master key or the secondary key (keyToUse) is set to secondary.

This limits the implementation of SCG reactivation caused when reconfiguration with sync is performed, thereby limiting the power consumption of the terminal device 100.

Furthermore, if the RRC reconfiguration message received from the base station device 200 in SCG deactivation includes the MCG reconfiguration with sync parameter but not the SCG reconfiguration with sync, the terminal device 100 does not resume UL transmission of the SCG.

This limits the implementation of SCG reactivation caused when reconfiguration with sync is performed, thereby limiting the power consumption of the terminal device 100.

Also, upon receiving an SCG deactivation instruction from the base station device 200, the terminal device 100 performs Processing A on radio bearers that meet Condition A.

Condition A is being an SCG bearer, or being a split bearer with a Primary Path set to the SCG.

Processing A is processing of immediately transmitting or discarding data for which transmission has not completed in the PDCP entity of a radio bearer that satisfies Condition A. Also, Processing A may be processing in which, when a request for re-establishment of the PDCP entity of a radio bearer that satisfies Condition A is issued, the transmission of the data for which transmission has not completed in the process of the PDCP entity re-establishment is not immediately performed but is performed at (after) SCG reactivation. Furthermore, Processing A may be processing of discarding an SDAP Control PDU when the PDCP entity of a radio bearer that satisfies Condition A receives the SDAP Control PDU from upper layers.

This limits the implementation of SCG reactivation due to the occurrence of UL transmission, thereby limiting the power consumption of the terminal device 100.

Furthermore, when the RRC of the terminal device 100 receives an SCG deactivation instruction from the base station device 200, it notifies the SDAP associated with the radio bearer (DRB) that satisfies Condition A of Information A.

Information A is information indicating that UL transmission is not possible with the DRB, such as that UL transmission is prohibited (stopped) with the DRB, or that the cell group associated with the DRB is in deactivation.

This limits the implementation of SCG reactivation due to the occurrence of UL transmission, thereby limiting the power consumption of the terminal device 100.

Furthermore, in SDAP, if the DRB associated with the first QoS flow is changed and the DRB before the change is the DRB that is notified from RRC, the terminal device 100 does not transmit the SDAP Control SDU to the DRB before the change.

Also, the base station device 200 may be implemented such that an end marker is not generated when the terminal device 100 is in SCG deactivation. For example, in SCG deactivation, the base station device 200 may control such that an end marker is not generated by controlling such that the QoS flow that is associated with a DRB that is an SCG bearer or a split bearer with a Primary Path set to the SCG is not re-associated with another DRB, for example. Furthermore, before the SCG deactivation instruction of processing 104 or at the SCG deactivation instruction in the first embodiment, the base station device 200 may control such that an end marker is not generated by controlling such that all or some of the QoS flows associated with a DRB that satisfies at least the second condition are (re-)associated with a DRB that does not satisfy at least the second condition, for example.

This limits the implementation of SCG reactivation due to the occurrence of UL transmission, thereby limiting the power consumption of the terminal device 100.

Furthermore, the base station device 200 may instruct (specify) whether the terminal device 100 issues an SCG reactivation request to the base station device when UL data is generated (arrived) or the terminal device 100 spontaneously performs SCG reactivation. For example, the terminal device 100 performs the following processing.

Upon receiving an SCG deactivation instruction from the base station device 200, the RRC of the terminal device 100 transmits Notification A to the PDCP entity of the radio bearer that meets Condition A. Notification A is a notification indicating that the SCG is deactivated or that UL transmission on the SCG side is prohibited (interrupted). When the PDCP entity of the radio bearer that meets Condition A receives data from upper layers, the PDCP entity of the terminal device 100 notifies the RRC of the terminal device 100 that UL data is generated. The RRC of the terminal device 100 generates an SCG deactivation request and transmits it to the base station device 200. Upon receiving an SCG reactivation message from the base station device 200, the RRC of the terminal device 100 transmits a notification indicating that the SCG is reactivated or that UL transmission on the SCG side is initiated (resumed) to the PDCP entity of the radio bearer to which the second notification is transmitted.

Alternatively, when UL data is generated in the MAC, the terminal device 100 performs a random access procedure to enable UL transmission. The terminal device 100 first performs any SCG reconfiguration with sync that was not performed immediately.

This allows the terminal device 100 to perform appropriate processing when UL transmission to and RLC bearer on the SCG side occurs in SCG deactivation. As such, the terminal device 100 can notify the base station device 200 that UL transmission has occurred on the SCG side RLC bearer in SCG deactivation, and perform SCG reactivation autonomously or by an instruction from the base station device 200.

### OTHER EMBODIMENTS

Each embodiment may be combined. The messages in the sequence do not need to be performed in order, and the order may be rearranged. Also, some messages in the sequence may not be performed. For example, the processing in SCG deactivation in the terminal device 100 may be performed as long as the terminal device 100 is in SCG deactivation, and messages in the sequence may be omitted.

In each embodiment, functions and processing described as those of the terminal device 100 may be functions and processing of the base station device 200. In each embodiment, functions and processing described as those of the base station device 200 may be functions and processing of the terminal device 100.

In each embodiment, “radio bearers” may be signaling radio bearers, may be data radio bearers, or may be both signaling radio bearers and data radio bearers.

In each embodiment, “A may be rephrased as B” may include rephrasing B as A, in addition to rephrasing A as B.

Additionally, in each embodiment, when condition “A” and condition “B” are contradictory conditions, condition “B” may be expressed as “other” condition of condition “A”.

A summary is given below.

A first radio communication device (base station device) including: a second transmission unit configured to transmit a message to a second radio communication device (terminal device); and a second processing unit, wherein the second processing unit is configured to, when a first radio bearer of the second radio communication device is in a suspended state, cause a first RRC message that is to be transmitted to the second radio communication device to include a first parameter but not a second parameter when the second radio communication device resumes secondary cell group transmission for the first radio bearer, and cause the first RRC message to be transmitted to the second radio communication device to include the first parameter and the second parameter when the second radio communication device does not resume secondary cell group transmission for the first radio bearer.

The first parameter is a reconfiguration with sync parameter for a secondary cell group, and the second parameter is a parameter indicating that the SCG is in a deactivated state.

The first radio bearer is a radio bearer associated with the secondary cell group.

The first RRC message is an RRC resumption message or an RRC reconfiguration message.

A second radio communication device (terminal device) including: a reception unit configured to receive a message from a first radio communication device, and a processing unit, wherein the processing unit is configured to, when a first radio bearer of the second radio communication device is in a suspended state, refrain from resuming secondary cell group transmission for the first radio bearer when a first RRC message received from the first radio communication device includes a first parameter and a second parameter, and resume secondary cell group transmission for the first radio bearer when the first RRC message includes the first parameter and does not include the second parameter.

The first parameter is a reconfiguration with sync parameter for a secondary cell group, and the second parameter is a parameter indicating that the SCG is in a deactivated state.

The first radio bearer is a radio bearer associated with the secondary cell group.

The first RRC message is an RRC resumption message or an RRC reconfiguration message.

In each embodiment, an example of a device is described, but the technique of the present disclosure is not limited to this and can be applied to other electronic devices, such as electronic devices mounted on automobiles, trains, airplanes, and artificial satellites, electronic devices transported by drones or the like, robots, AV equipment, home appliances, office equipment, vending machines, and other home equipment.

In addition, in each embodiment, E-UTRA and NR are used as radio access technologies, and EPC and 5GC are used as core networks, but the application of the technique of the present disclosure is not limited to these examples. For example, the format of the present disclosure may be applied to radio access technologies and networks of different generations, such as the sixth generation and the seventh generation.

Furthermore, the present disclosure is not limited to the above-described embodiments, and various modifications can be made.

Although each embodiment has been described in detail with reference to the drawings, the specific configuration is not limited to each embodiment.

One disclosure allows for the limitation of power consumption of a terminal device in activating communication between the terminal device for which the secondary cell group is in an inactive state and a secondary base station device in MR-DC.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A second radio communication device comprising:
a receiver configured to receive a Radio Resource Control (RRC) message from a first radio communication device; and
a controller configured to, when the RRC message includes a first parameter and a second parameter, control to perform processing according to the second parameter after performing processing of resuming a radio bearer in a suspended state.

2. The second radio communication device according to claim 1, wherein the first parameter is a reconfiguration with sync parameter for a secondary cell group, and the second parameter is a parameter indicating that the SCG is in a deactivated state.

3. The second radio communication device according to claim 1, wherein the radio bearer is a radio bearer associated with a secondary cell group.

4. The second radio communication device according to claim 1, wherein the RRC message is an RRC resumption message or an RRC reconfiguration message.

5. The second radio communication device according to claim 1, wherein the radio bearer is a data radio bearer.

6. A first radio communication device comprising:
a transmitter configured to transmit a Radio Resource Control (RRC) message to a second radio communication device; and
a controller configured to control, by controlling to cause the RRC message to include a first parameter and a second parameter, to cause the second radio communication device to perform processing according to the second parameter after performing processing of resuming a radio bearer in a suspended state.

7. The first radio communication device according to claim 6, wherein the first parameter is a reconfiguration with sync parameter for a secondary cell group, and the second parameter is a parameter indicating that the SCG is in a deactivated state.

8. The first radio communication device according to claim 6, wherein the radio bearer is a radio bearer associated with a secondary cell group.

9. The first radio communication device according to claim 6, wherein the RRC message is an RRC resumption message or an RRC reconfiguration message.

10. The first radio communication device according to claim 6, wherein the radio bearer is a data radio bearer.

11. A radio communication system comprising:
a first radio communication device configured to transmit a Radio Resource Control (RRC) message; and
a second radio communication device configured to receive the RRC message, and when some or all of configured radio bearers are in a suspended state and the RRC message includes a first parameter and a second parameter, control to perform processing according to the second parameter after performing processing of resuming the radio bearers in the suspended state.
